(19) United States
(12) Patent Application Publication
(10) Pub. No.: US 2026/0104622 A1
(43) Pub. Date: Apr. 16, 2026

(54) TUNABLE NONLINEAR PHOTONIC STRUCTURE

(71) Applicant: City University of Hong Kong, Kowloon (HK)

(72) Inventors: Haochuan LI, Sha Tin (HK); Xiaoting LI, Sha Tin (HK); Wenzhao SUN, Dongguan (CN); Cheng WANG, Kowloon City (HK)

(21) Appl. No.: 18/917,721

(22) Filed: Oct. 16, 2024

(51) Int. Cl. G02F 1/35; G02F 1/355

(52) U.S. Cl. CPC G02F 1/3546; G02F 1/3548; G02F 1/3553; G02F 1/3556

(57) ABSTRACT

Embodiments can include a photonic structure comprising: a substrate; a waveguide formed over the substrate; an insulator layer formed over the waveguide, wherein the waveguide is formed of nonlinear optical material; and a tuning structure integrally formed on the photonic structure with the waveguide, the tuning structure configured for tuning the waveguide.

### BACKGROUND

Embodiments herein relate generally to photonic structures in general and specifically to a tunable nonlinear photonic structure.

Photonics involves generation, detection, and manipulation of photons through emission, transmission, modulation, signal processing, switching, amplification and sensing. Materials employed in photonic structures include silicon (Si), indium phosphide (InP), gallium arsenide (GaAs), silicon nitride (SiN), and lithium niobate (LN). Thin-film periodically poled lithium niobate (TF-PPLN) devices, renowned for their strong optical nonlinearity and excellent light confinement, are expected to become important building blocks in the next generation of optical communication and quantum information processing systems [1]. Due to the substantially enhanced optical intensity in tightly confined waveguides, TF-PPLN wavelength convertors exhibit more than one order of magnitude higher normalized conversion efficiencies compared to their bulk counterparts [2-4]. These highly efficient TF-PPLN waveguides have enabled many high-performance nonlinear devices, including resonator-based ultra-efficient wavelength converters [5,6], broadband optical parametric amplifiers [7,8] and entangled photon-pair sources [9,10].

### BRIEF DESCRIPTION

Embodiments herein can include a photonic structure comprising: a substrate; a waveguide formed over the substrate; an insulator layer formed over the waveguide, wherein the waveguide is formed of nonlinear optical material; and a tuning structure integrally formed on the photonic structure with the waveguide, the tuning structure configured for tuning the waveguide.

Embodiments herein can further include a ferroelectric crystal wafer with substrate; a plurality of photonic device regions patterned in the ferroelectric crystal wafer, wherein respective ones of the photonic device regions include a waveguide formed over the substrate and at least one tuning structure for tuning a spectrum of the waveguide.

Embodiments herein can further include periodically poling, in respective device regions of a ferroelectric crystal wafer, a waveguiding material layer to impose alternatingly poled regions on the waveguiding material layer, wherein the waveguiding material layer is formed of nonlinear optical material; patterning, in respective ones of the device regions, the waveguiding material layer to define a waveguide; and fabricating in respective ones of the device regions, at least one tuning structure for tuning a quasi-phase matching (QPM) spectrum of the waveguide.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is a perspective view illustrating a system for tuning the QPM spectrum of TF-PPLN optical waveguides integrated on a ferroelectric crystal photonic structure with insets showing (a) the segmented heating powers, (b) recovered quasi phase matching (QPM) spectrum (b) after tuning with segmented tuning structure as depicted in insert (a), and (c) broadened QPM spectrum due to thickness variation before tuning according to one embodiment.

FIG. 2 is a schematic cross-sectional view of a photonic chip according to one embodiment.

FIG. 3 is a schematic perspective view of a photonic chip according to one embodiment.

FIG. 4A is a fabrication stage view depicting a widthwise cross section of multiple TF-PPLN waveguides (e.g., here we depict three in total as an example) integrated on the ferroelectric crystal chip or wafer according to one embodiment.

FIG. 4B is a fabrication stage view depicting a widthwise cross section of multiple TF-PPLN waveguides integrated on the ferroelectric crystal wafer, after formation of poling electrodes, according to one embodiment.

FIG. 4C is a fabrication stage view depicting a lengthwise cross section of multiple TF-PPLN waveguides integrated on the ferroelectric crystal wafer, after formation of poling electrodes and application of poling, according to one embodiment.

FIG. 4D is a fabrication stage view depicting a widthwise cross section of multiple PPLN waveguides integrated on the ferroelectric crystal wafer, after removal of poling electrodes and patterning of waveguides, according to one embodiment.

FIG. 4E is a fabrication stage view depicting a widthwise cross section of multiple PPLN waveguides integrated on the ferroelectric crystal wafer, after patterning of tuning structures, according to one embodiment.

FIG. 4F is a fabrication stage view depicting a widthwise cross section of multiple PPLN waveguides integrated on the ferroelectric crystal wafer, after formation of air trenches, according to one embodiment.

FIG. 5 is a schematic perspective view depicting periodic poling of waveguiding material according to one embodiment.

FIG. 6A is a top view depicting a tuning structure provided by a heating tuning structure according to one embodiment.

FIG. 6B is an exploded view of section E of FIG. 6A.

FIG. 7 is a schematic view of a grating structure designed to efficiently couple light into and out of our TF-PPLN devices (vertical coupling) for use in performing wafer-scale waveguide tuning according to one embodiment.

FIG. 8 is a fabrication view with insets showing (a) a fabricated 4-inch LNOI wafer patterned with finger electrodes for periodic poling; (b) the wafer after periodic poling and patterning of optical waveguides; (c) the final cleaved TF-PPLN chip wire-bonded to a printed circuit board (PCB); (d-f) Cross-sectional schematics of the fabrication process flow, specifically (d) high voltage poling; (e) optical waveguide formation using RIE etching; (f) fabrication of the segmented micro-heaters; (g) a close-up microscope image of the fabricated segmented micro-heaters (scale bar: 250 μm); and (h) a measured QPM wavelength as a function of increasing heating power.

FIG. 9 depicts in insets (a-c) measured second harmonic generation (SHG) intensities as functions of pump wavelengths for a 6 mm TF-PPLN waveguide before applying tuning currents (a), after optimization of the heater powers (b), and with an arbitrary set of tuning parameters (c). (d-f) DC powers applied to each segmented micro-heater for the scenarios in (a-c) respectively, according to one embodiment.

FIG. 10 in insets (a-b) depict measured SHG intensities as functions of pump wavelengths for a 1 cm TF-PPLN waveguide before (a) and after (b) applying tuning currents. (c) DC powers applied to each segmented micro-heater for the scenario in (b), according to one embodiment.

FIG. 11 depicts simulated quasi-phase matching (QPM) spectra with (right column) and without (left column) segmented thermal tuning in the cases of linearly increasing film thickness as shown in insets (a-d) and a realistic thickness profile as shown in insets (e-h); wherein insets (a) and (e) show the local QPM wavelengths along the TF-PPLN waveguides compared with the target QPM wavelength (dashed); wherein (c) and (g) correspond to the simulated QPM spectra in comparison with the ideal QPM spectrum (dashed); wherein (b) and (f) show the local QPM wavelength distributions after the center QPM wavelengths in each section are aligned by the segmented micro-heaters; wherein (d) and (h) show the corresponding recovered QPM spectra by the micro-heaters, according to one embodiment.

### DETAILED DESCRIPTION

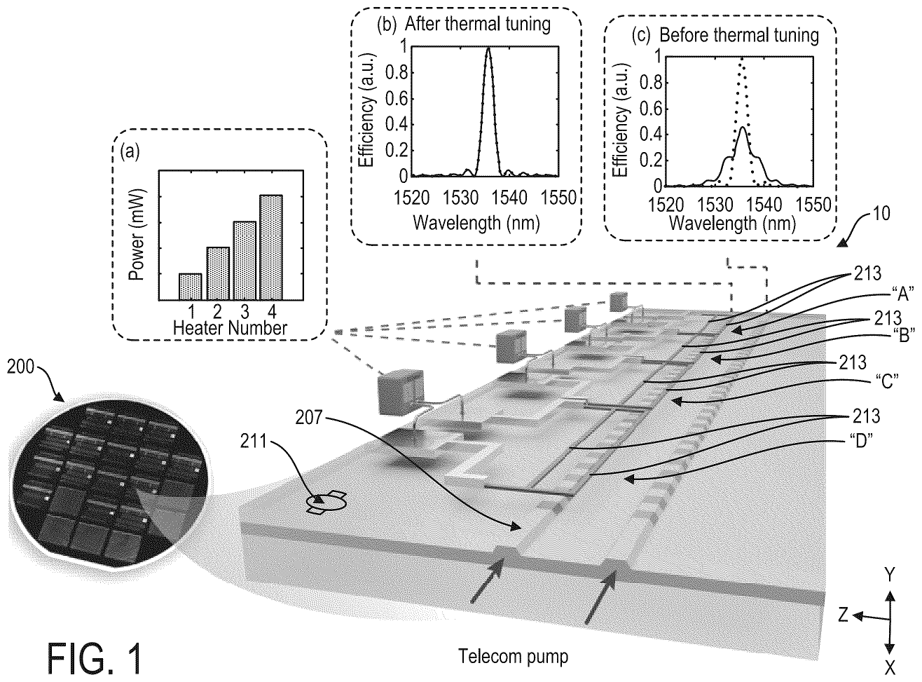

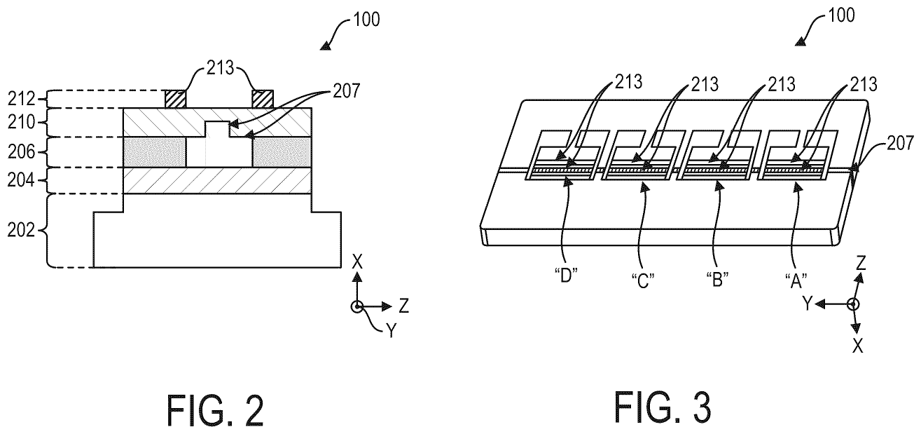

In FIG. 1 there is shown photonic structure 10 for tuning a waveguide 207 integrally formed therein. Photonic structure 10 can include a waveguide 207 having an associated one or more tuning structure 213 for tuning waveguide 207. Referring to insets of FIG. 1, inset (a) depicts tuning with segmented tuning structures, inset (b) depicts recovered QPM spectrum after tuning with segmented structures, and (c) broadened QPM spectrum due to thickness variation before tuning. Photonic structure 10 can be provided, e.g., by a photonic chip 100 or a ferroelectric crystal wafer 200 from which photonic chips 100 can be formed. Further aspects of photonic structure 10 including waveguide 207 and tuning structures 213, are set forth herein in reference to FIGS. 2-11.

A photonic structure provided by a photonic chip 100 is shown in FIG. 2. Photonic chip 100 can include an integrally fabricated waveguide 207 and an integrally fabricated tuning structure 213 for tuning a spectrum of waveguide 207. Integrally fabricated waveguide 207 and integrally fabricated tuning structure 213 can be fabricated at different stages of a multistage wafer-scale photonic devices fabrication process in which structure supported by the same wafer is processed at each stage. Photonic chip 100 as shown in FIG. 2 can include waveguide 207 and tuning structure 213 for tuning waveguide 207. Waveguide 207 and tuning structure 213 can be integrally fabricated on a photonic chip 100 at different stages of a multistage wafer-scale fabrication process in which structure supported by the same wafer is processed at each stage. In one embodiment, photonic chip 100 can be configured so that the tuning structure 213 can be used to tune a spectrum of waveguide 207.

In one embodiment, waveguide 207 can be formed of nonlinear optical material. In one embodiment, waveguiding material layer 206 can be formed of nonlinear optical material provided by lithium niobate (LN). Waveguide 207 in one embodiment can be patterned from a periodically poled LN waveguiding material layer.

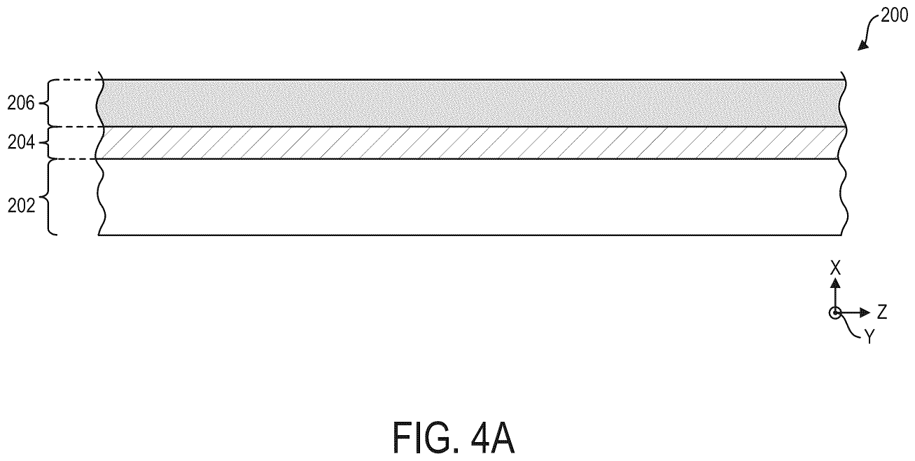

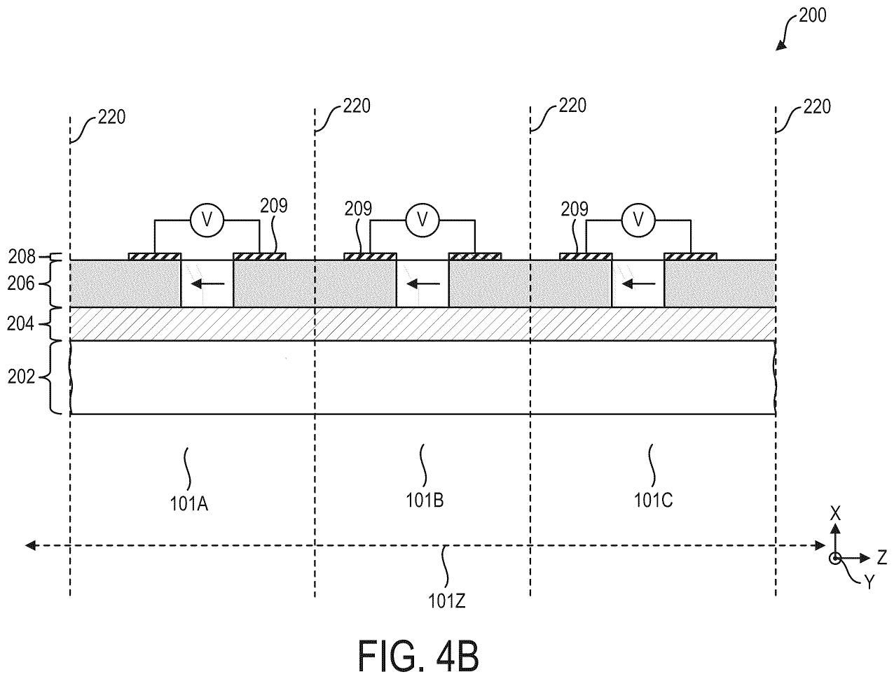

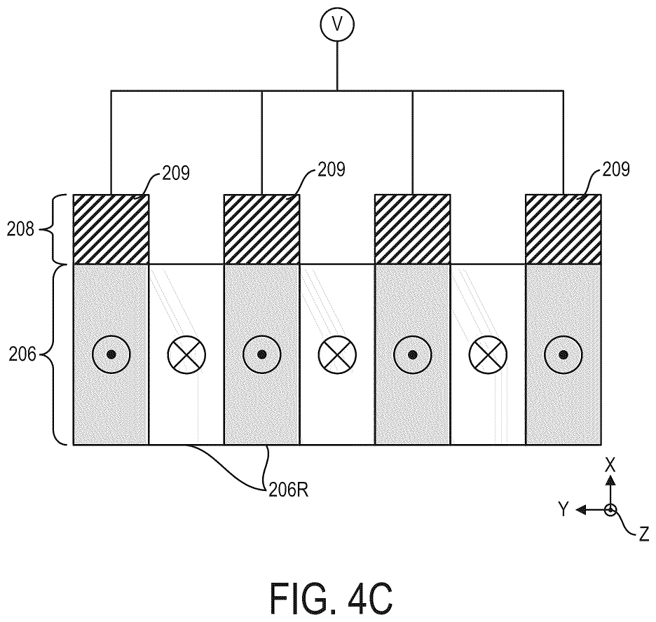

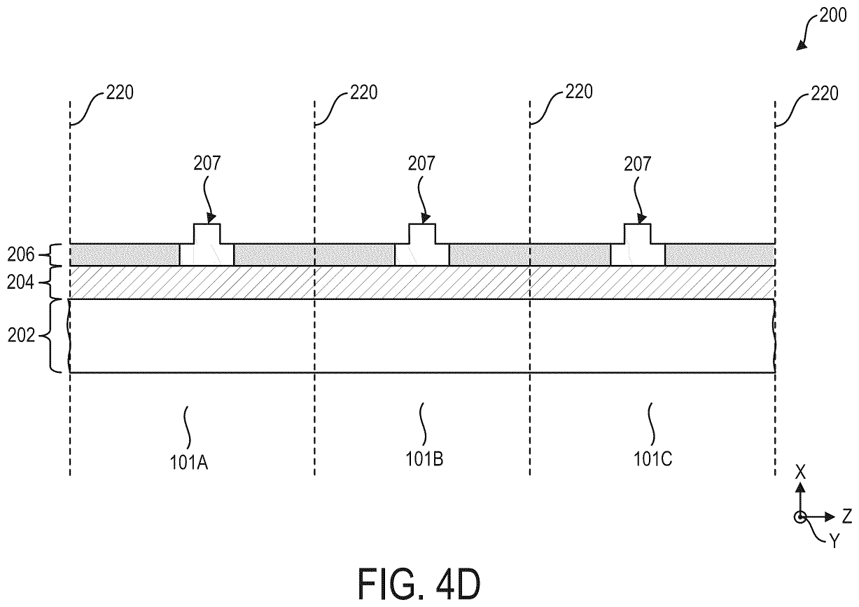

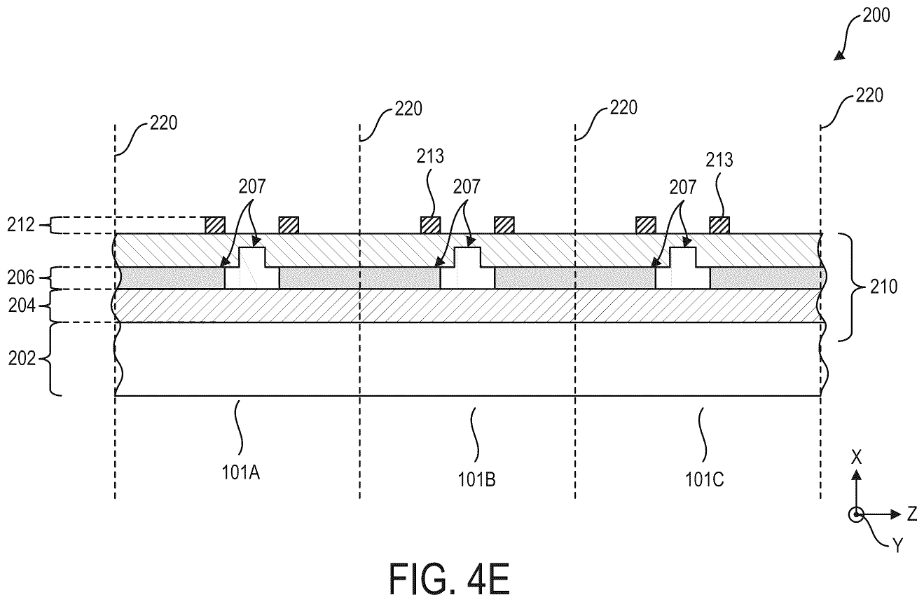

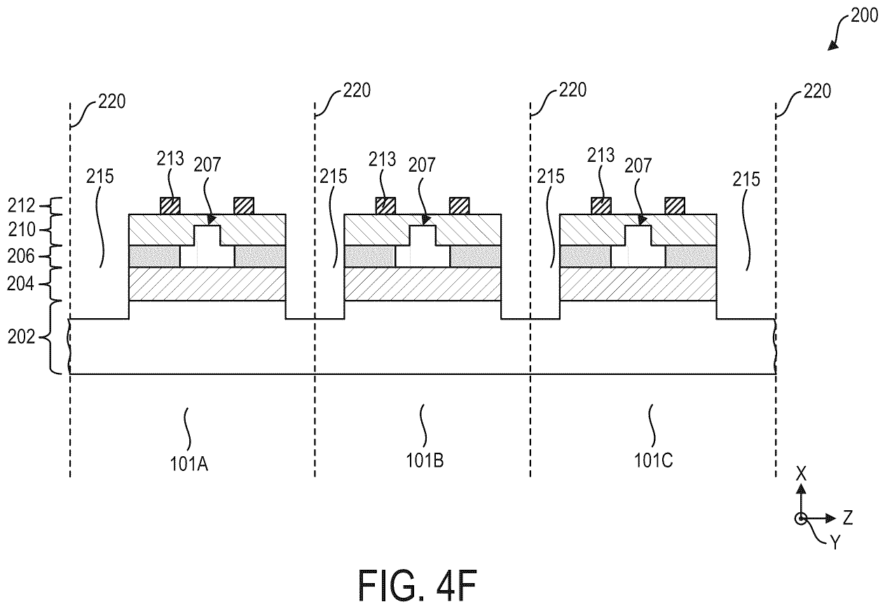

FIG. 3 depicts a perspective view of photonic chip 100. Photonic chip 100 can be fabricated on a ferroelectric crystal wafer 200 as shown in FIGS. 4A-4F.

In one embodiment, photonic chip 100 can be configured so that tuning structure 213 can be used to tune a quasi-phase matching (QPM) spectrum of waveguide 207. Tuning structure 213 can be configured to tune waveguide 207 by delivering energy to waveguide 207 so that a dimension of waveguide, including one or more of film thickness, width or etch depth, in a section thereof can be altered. In a further aspect, tuning structure 213 can be configured to tune waveguide 207 by delivering heat energy to waveguide 207 so that a dimension of waveguide 207 in a section thereof is altered. In one embodiment, tuning structure 213 can be provided by a micro-heater, and photonic chip 100 can include a plurality of such micro-heaters disposed in segments along the propagation direction of waveguide 207. In one embodiment, tuning of waveguide 207 can include applying DC power to a set of such micro-heaters. Embodiments herein recognize that applying DC power to a segmented micro-heater aside waveguide 207 can change an optical refractive index of the waveguide 207. The change in optical refractive index of waveguide 207 can compensate for thickness variations of waveguide 207, thus changing a dimension of waveguide 207, which includes one or more of film thickness, width or etch depth. Embodiments herein recognize, accordingly, that applying DC power to the segmented micro-heaters aside waveguide 207 can result in a dimension of waveguide 207 in one or more section thereof being changed.

In one embodiment, photonic chip 100 can be fabricated on and with use of a ferroelectric crystal wafer 200 set forth throughout the views including with respect to FIGS. 4A-4F herein. Photonic chip 100 can be provided in the form of a photonic integrated circuit chip (or alternatively a discrete photonic device chip produced by dicing and cleaving of ferroelectric crystal wafer 200).

In a further aspect as set forth in FIG. 2, photonic chip 100 can include substrate 202 defining a substrate layer, insulator layer 204, waveguiding material layer 206, insulator layer 210 and metallization layer 212. In one embodiment, insulator layer 204 can be deposited on substrate 202, waveguiding material layer 206 can be bonded on insulator layer 204, insulator layer 210 can be deposited on waveguiding material layer 206 and metallization layer 212 can be deposited on insulator layer 210.

In one embodiment, insulator layer 204 and insulator layer 210 can be provided by an oxide, e.g., silicon dioxide (SiO₂). In one embodiment, waveguiding material layer 206 can be formed of nonlinear optical material. In one embodiment, waveguiding material layer 206 can be formed of nonlinear optical material provided by lithium niobate (LN). In one embodiment, by use of wafer-scale processes herein, waveguiding material layer 206 can be a periodically poled LN layer that has been subject to periodic poling for imposing of poled regions on waveguiding material layer 206. In one embodiment, tuning structure 213 can be patterned from metallization layer 212. Waveguiding material layer 206 in one embodiment can comprise a material that can be “poled” (i.e., exhibits the ferroelectric properties). Waveguiding material layer 206 in one embodiment can possess commercialized thin-film wafer production. Waveguiding material layer 206 in one embodiment can comprise lithium niobate (LN). Waveguiding material layer 206 in one embodiment can comprise periodically poled lithium niobate (PPLN).

In another aspect, waveguiding material layer 206 can be integrally formed on photonic chip 100 with layers 202, 204, 210 and 212, and with tuning structure 213 which can be patterned from metallization layer 212. Waveguide 207 patterned from waveguiding material layer 206 can be patterned as a ridge waveguide. Photonic chip 100 can be produced using photolithography processing techniques including one or more of e.g., substrate preparation, photoresist application, soft baking, alignment and light exposure through a mask, post-exposure baking, etching, photoresist removal, and the like. Photolithography processing facilitates precision in the component and spacing dimensions of photonic chip 100.

FIG. 3 depicts photonic chip 100 as shown in FIG. 2 in an alternate perspective defined by a lengthwise perspective view of photonic chip 100 (depicting the view extending co-extensively with the y-axis of the depicted reference coordinate system of FIGS. 2 and 3).

As best seen in FIG. 3, photonic chip 100 can include a plurality of tuning structures 213 that can be formed co-extensively with a length of waveguide 207. As best seen in FIG. 3, photonic chip 100 can be configured to include a plurality of tuning structures integrally formed on photonic chip 100 configured for tuning of waveguide 207 at various sections along the length of waveguide 207.

As best seen in FIG. 3, photonic chip 100 can include a first tuning structure integrally formed at location A of photonic chip 100, a second tuning structure 213 integrally formed at location B of photonic chip 100, a third tuning structure 213 integrally formed at location C of photonic chip 100 and the fourth tuning structure 213 integrally formed at location D of photonic chip 100. The first tuning structure 213 can be configured for tuning the first section of waveguide 207. The second tuning structure 213 can be configured for tuning a second section of waveguide 207. The third tuning structure 213 at C can be configured for tuning a third section of waveguide 207 and the fourth tuning structure 213 at D can be configured for tuning a fourth section of waveguide 207. Photonic chip 100 can include, e.g., zero to N tuning structures 213 distributed for tuning of different sections of waveguide 207 along a length of waveguide 207. In a further aspect, the various tuning structures 213 disposed along a length of waveguide 207 can include respective lengths that are about equal. In a further aspect, spacing distances between the various tuning structures 213 disposed along a length of waveguide 207 can be about equal. In a still further aspect, the various tuning structures 213 at A, B, C, and D can be provided by micro-heaters for heating respective section of waveguide 207. The set of micro-heaters at A, B, C, D can define segmented micro-heaters. The segmented micro-heaters can be of about equal length and can have about equal spacing. In reference to, e.g., FIGS. 2 and 3, there is set forth herein a photonic structure comprising: a substrate; a waveguide 207 formed over the substrate; an insulator layer 210 formed over the waveguide, wherein the waveguide is formed of nonlinear optical material; and a tuning structure 213 integrally formed on the photonic structure with the waveguide 207, the tuning structure 213 configured for tuning the waveguide 207.

Fabrication of multiple TF-PPLN waveguides with the same configuration as photonic chip 100 on and with use of a ferroelectric crystal wafer 200 according to one embodiment is set forth in reference to the fabrication stage views of FIGS. 4A-4F. In FIGS. 4A-4F there is depicted a photonic structure provided by a ferroelectric crystal wafer 200 in various intermediary stages of fabrication.

In FIG. 4A, there is shown a photonic structure provided by ferroelectric crystal wafer 200. Ferroelectric crystal wafer 200 in one embodiment can be provided by a lithium niobate on oxide (LNOI) wafer. Ferroelectric crystal wafer 200 as shown in FIG. 4A can include substrate 202, insulator layer 204 and waveguiding material layer 206. In one embodiment, substrate 202 can be provided by a silicon substrate, insulator layer 204 can be provided by an oxide layer, e.g., SiO₂, and waveguiding material layer 206 can be provided by lithium niobate (LN). Insulator layer 204, in one embodiment, can be deposited on substrate 202. Waveguiding material layer 206, in one embodiment can be bonded to insulator layer 204.

Fabricating of waveguides with use of waveguiding material layer 206 is set forth in reference to FIGS. 4B-4F. Referring to FIG. 4B, ferroelectric crystal wafer 200 can include a plurality of photonic device regions such as 101A-101C that are delimited by device region boundary lines 220. For completion of wafer-scale fabricating processes, which will be referenced in connection with FIG. 4F, ferroelectric crystal wafer 200 can be cleaved and diced along at least one device region boundary line 220 in order to derive one or more individual photonic chip 100 as shown in FIGS. 2 and 3. Each photonic chip 100 (FIGS. 2 and 3) can be defined by circuitry of a particular device region of the wafer based structure provided by ferroelectric crystal wafer 200 prior to cleaving and dicing of ferroelectric crystal wafer 200. While the photonic device regions 101A-101C depict photonic device regions and resulting photonic chips 100 as having a single waveguide 207 per device region and chip, it will be understood that the respective photonic device regions 101A-101C can include more than one waveguide 207 per device region 101A-101C and that resulting photonic chips 100 can include more than one waveguide 207. Resulting chips 100 can include more than one waveguide, e.g., by having more than one waveguide per device region, and/or by encompassing more than one device region.

Embodiments herein recognize that while a limited number of individual devices defined by waveguides 207 are set forth in the embodiment of FIG. 4B-4F, one thousand (1,000) or more TF-PPLN devices can be fabricated on a single LNOI wafer in realistic conditions. In one embodiment, such an LNOI wafer can be subject to dicing and cleaving to define 1,000 or more photonic chips 100 each having a single TF-PPLN device, and in one embodiment, all of the 1,000 or more TF-PPLN devices can remain on a produced photonic chip 100 defining a wafer-scale photonic chip 100 that functions as system, e.g., a quantum computing system according to one embodiment.

In one embodiment, a ferroelectric crystal wafer 200 can be subject to wafer-scale integration (WSI) fabrication processing for production of a photonic chip 100 configured as a wafer-scale photonic chip. In such an embodiment, ferroelectric crystal wafer 200 can be regarded to define a photonic device region 101Z (FIG. 4B) comprising the entirety of the ferroelectric crystal wafer 200 and spanning photonic device regions 101A-101C. It will be understood that in such an embodiment where ferroelectric crystal wafer 200 is subject to fabrication processing for production of a photonic chip 100 configured as a wafer-scale photonic chip.

Further in respect to the fabricating stage view of FIG. 4B, metallization layer 208 can be deposited on waveguiding material layer 206 and then can be patterned using lithography processing to form electrodes 209. In one embodiment, metallization layer 208 can be provided by gold (Au). In one embodiment, metallization layer 208 can be provided by copper (Cu), aluminum (Al), silver (Ag) or another suitable metal or metal alloy. In one embodiment, metallization layer 208 can be deposited with use of thermal of evaporation and lift-off.

Electrodes 209 can define a temporary fabrication structure for use in periodic poling of waveguiding material layer 206, which can be provided by lithium niobate (LN). In reference to the fabrication stage view of FIG. 4B, voltage can be applied to electrodes 209 for performance of periodic poling of waveguiding material layer 206. On application of voltage to electrodes 209, an electric field can be applied to waveguiding material of waveguiding material layer 206. The application of an electric field to the waveguiding material layer can periodically invert the polarization directions of the domains along the propagation directions of the waveguiding material layer 206. Material defining waveguiding material layer 206 can include ferroelectric crystalline material. Waveguiding material layer 206 can include, e.g., lithium niobate (LN), potassium titanyl phosphate (KTP), lithium tantalate (LT).

Referring to FIG. 4C, periodic poling can produce regions 206R with alternating polarization orientation in a ferroelectric crystal material. The regions 206R can be regularly spaced, with period fitting the needs of different wavelength conversion processes. A periodically poled structure can achieve quasi-phase-matching (QPM) in material defining the structure. Periodically poled crystals can be employed as nonlinear optical material. Periodically poled crystals are more efficient at second-harmonic generation than crystals of the same material without periodic structure. The material for the crystals can include all ferroelectric crystal material with relatively strong second nonlinearity. Materials can include, e.g., lithium niobate (LN), potassium titanyl phosphate (KTP), lithium tantalate (LT). The periodic poled structure is created in the ferroelectric crystal using a range of methodologies, including a pulsed electric field, electron bombardment, thermal pulsing, or other methods can be used to reposition the atoms in the lattice, creating ferroelectric domain inversions.

Phase matching involves ensuring that the relative phase between two or more light frequencies remains constant as the light passes through a crystal. In certain materials, the refractive index can vary with the frequency of light traveling through them. Consequently, the phase relationship between photons of different frequencies can change as they propagate through the crystal unless the crystal is specifically phase matched for those frequencies. Effective nonlinear conversion of input photons relies on maintaining a constant phase relationship between the input and generated photons throughout the crystal.

The present embodiments acknowledge that if the phase relationship between input and generated photons does not remain constant throughout the crystal, the generated photons may interfere destructively with each other, thus limiting the number of photons exiting the crystal.

Periodically poled lithium niobate (PPLN) is a deliberately engineered approach designed for quasi-phase matching. In this context, “engineered” refers to the periodic inversion (poling) of the orientation of the lithium niobate crystal. The inverted sections of the crystal produce photons that are 180° out of phase with those that would have been generated if the crystal had not been poled. By selecting the appropriate periodicity for inverting the crystal's orientation, the newly generated photons are expected to interfere constructively with previously generated photons, resulting in increased photon generation efficiency as light travels through the PPLN. The poling periodicity can be tailored such that the phase is “reset” periodically when the number of generated photons at a specific point in the crystal is maximized.

Furthermore, the embodiments recognize that lithium niobate is a ferroelectric crystal, meaning that each unit cell in the crystal possesses a small electric dipole. The orientation of this electric dipole within a unit cell can be influenced by the positions of the niobium and lithium ions within that unit cell. Additionally, an intense electric field is required to be applied to invert the crystal structure within a unit cell, thereby altering the orientation of the electric dipole. This electric field typically exhibits an order of magnitude in the kilovolts per millimeter range and is applied for a brief duration, typically only a few milliseconds. After the high voltage pulses application, the inverted domains of the crystal retain their dipole orientation within the crystal structure permanently.

Upon completion of periodic poling of waveguiding material layer 206, waveguiding material layer 206 will be formed to fit the quasi-phase matching (QPM) condition. Periodic poling can be employed for creation of quasi-phase-matching (QPM) condition in ferroelectric crystal waveguiding material layer 206.

Through the process of periodic poling, periodically poled domains can be established within waveguiding material layer 206. These domains can be spaced at intervals that can fulfill the QPM condition to achieve the specific nonlinear wavelength conversion process. Once the periodic poling voltage is applied, the waveguiding material layer 206, when made of lithium niobate (LN), becomes what is known as periodically poled lithium niobate (PPLN). PPLN is considered as an engineered quasi-phase matched structure, meaning that the crystal orientation of lithium niobate that constitutes the waveguiding material of waveguiding material layer 206 is periodically reversed, creating alternating reversed domains within the layer.

Ferroelectric crystal fabrication processes set forth herein facilitate placement of elements with lithographic precision. In another aspect, the production of PPLN defined by waveguiding material layer 206 can be facilitated by use of lithographic precision placement of electrodes 209 so that differently poled regions 206R are defined within waveguiding material layer 206, at precisely defined targeted locations. In one embodiment, the electric field applied to invert crystals defining waveguiding material of waveguiding material layer 206 can be, e.g., about 32 kV/mm or greater, and in one embodiment about 32 kV/mm or greater (the poling electric field is normally 32 kV/mm or above). In one embodiment, the electric field applied to invert crystals defining waveguiding material of waveguiding material layer 206 can be, e.g., about 32 kV/mm or greater.

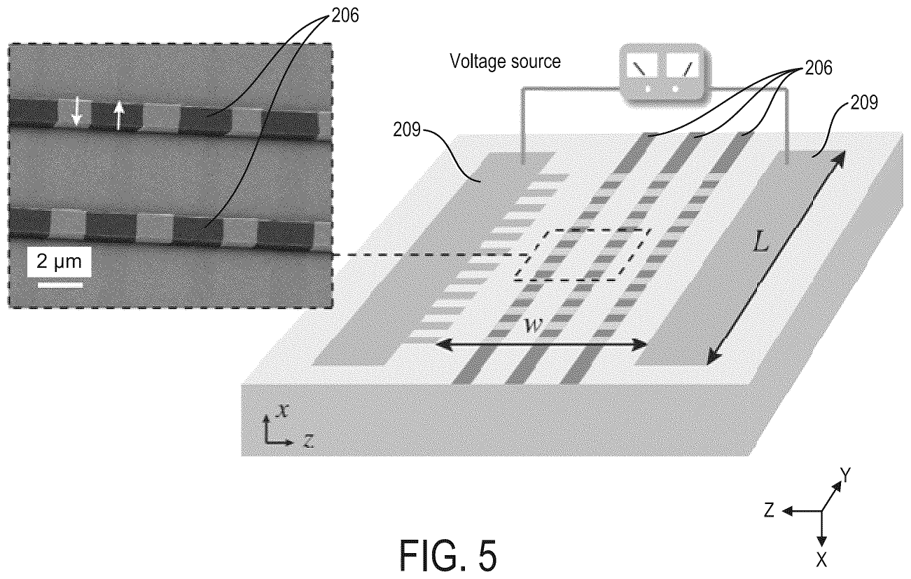

After application of electric field to waveguiding material layer 206, alternately poled regions 206R can be formed in the waveguiding material layer 206. As seen from the XY-cross-section view of FIG. 4C, waveguiding material layer 206 can define alternately poled regions (with +/−z polarization direction) throughout a length of waveguiding material layer 206. To produce PPLN as shown in FIG. 4C, a periodic electrode structure provided by metallization layer 208 can be deposited on the waveguiding material layer 206 of the lithium niobate wafer, and DC voltage can be applied to electrodes 209 to invert the domains in the crystal periodically underneath and in between the positive and negative electrodes. The voltage can be controlled so that the poled regions 206R of waveguiding material layer are created with the targeted dimensions and duty cycle. Electrodes 209 can be dimensioned and positioned with lithographic precision to produce poled regions 206R of the targeted dimensions and period. Further aspects of periodic poling, in one embodiment, are set forth in FIG. 5.

Subsequent to periodic poling of waveguiding material layer 206 for transformation of thin film LN (TFLN) into thin film PLLN (TF-PPLN), ferroelectric crystal wafer 200 can be subject to further fabrication processing as described in connection with FIG. 4D.

Waveguiding material layer 206 can be patterned in one embodiment to define waveguide 207. Waveguide 207 can be, e.g., a standalone waveguide defining a waveguide photonic device or a waveguide forming a component part of another type of photonic device, e.g., a light source, a quantum light source with wavelength ranging from visible to mid-infrared, a frequency shifter, an optical switch, a photon detector, an up-conversion single-photon detector, a modulator, photodetector, or the like.

Referring now to FIG. 4D, further fabrication stages are described. In reference to FIG. 4D, on completion of periodic poling to define alternating poled domains within waveguiding material layer 206 (as shown in FIG. 4C), electrodes 209 for the performance of periodic poling can be removed as shown in FIG. 4D. In reference to FIG. 4D, after removal of electrodes 209, waveguiding material layer 206 can be patterned according to one embodiment so that waveguiding material layer 206 is first defined by photolithography and etched by reactive ion etching (RIE) into waveguide 207 as a ridge waveguide as shown in the respective photonic device regions 101A, 101B and 101C in FIG. 4D. Specifically, for performing the waveguide patterning by photolithography, 800 nm thick AZ7908 photoresist can be exposed at a dose of 230 mJ/cm² and developed for 60 s in FHD-5. The softbake and post-exposure bake temperatures can be about 90° C. and about 110° C. for about 60 s and about 60 s, respectively. In one embodiment, reactive ion etching (RIE) can be used to etch waveguiding material layer 206 into waveguides 207 as ridge waveguides as shown in the respective device regions shown in FIG. 4D.

On completion of fabrication processing depicted in FIG. 4D an insulator layer 210 can be deposited as a protection layer as shown in FIG. 4E. Insulator layer 210 can be deposited over all device regions of the wafer base structure as shown in FIG. 4E. Insulator layer 210 can be provided by an oxide, e.g., silicon dioxide (SiO₂) as shown in FIG. 4E. With insulator layer 210 formed, metallization layer 212 can be deposited on insulator layer 210 and patterned by lithographic patterning to define tuning structures 213 as shown in FIG. 4E. Tuning structures 213 in one embodiment can be provided by electrodes that are defined by photolithography of the metal layer 212. Tuning structures 213 of the respective device regions 101A-101C can facilitate tuning of respective waveguides 207 in each device region. In one embodiment, the metallization layer 212 can be provided by nickel chromium (NiCr) or another suitable metal alloy or metal material. In one embodiment, metal layer 212 can be formed by the metal deposition of thermal evaporation and standard lift-off process.

On completion of all the fabrication stages depicted in FIG. 4E, air trenches can be fabricated to further enhance the thermal tuning efficiency as shown in FIG. 4F. Referring to

FIG. 4F, lithographic processing can be performed to define air trenches 214 between the different device regions 101A-101C bounded by device region boundary lines 220. For fabrication of air trenches 214, thick photoresist (>7 μm, AZ2070) can be spun on the surface of the fabricated device as shown in FIG. 4E, and lithography and RIE etching can be performed to open windows at the trench areas. Specifically, for the RIE etching, deep dry etching of top insulator layer 210 (e.g., SiO₂), waveguiding material layer 206 (e.g., PPLN), buried insulator layer 204 (e.g., SiO₂), and optionally further into substrate 202 (e.g., Si), can be performed to form the air trenches 214. Air trenches 214 can improve thermal tuning efficiency. On completion of formation of air trenches 214 and in some use cases additional fabrication processing stages, e.g., patterning of terminations, the wafer-scale structure of FIG. 4F can be cleaved and diced along one or more device region boundary line 220 to produce one or more photonic chip 100, a representative one of which is shown in FIG. 2. In respective photonic device regions 101A-101C depicted in FIG. 4A-4F, there can be fabricated one or more waveguide 207. In some embodiments, a photonic chip 100 can be produced by cleaving and dicing along each device region boundary line 220 so that photonic chip 100 includes a single device region 101A-101C as depicted in FIG. 4A-4F. In some embodiments, a produced photonic chip 100 can include more than one of the device regions 101A-101C as depicted in FIG. 4A-4F. In one example, where photonic chip 100 is configured as a wafer-scale photonic chip defining a wafer-scale integration (WSI), photonic chip 100 can simultaneously include multiple device regions with the same configuration as device regions 101A, 101B or 101C depicted in FIGS. 4A-4F.

Tuning structures 213 as shown in FIGS. 4E and 4F can provide the ability to tune a waveguide 207 of respective photonic device regions 101A-101C.

Embodiments herein recognize that thickness variations along the length of waveguide 207 of the respective photonic device regions 101A-101C can impact the quasi-phase matching (QPM) spectrum of waveguide 207 along the length of waveguide 207. In order to achieve correction of QPM spectrum inconsistencies along the length of waveguide 207, the wafer-based structure of FIG. 4F can include integrated tuning structures 213, which in one embodiment can be defined by electrodes for receipt of applied DC voltages. In reference to, e.g., FIGS. 4E-4F, there is set forth herein a photonic structure comprising: a substrate; a waveguide 207 formed over the substrate; an insulator layer 210 formed over the waveguide, wherein the waveguide is formed of nonlinear optical material; and a tuning structure 213 integrally formed on the photonic structure with the waveguide 207, the tuning structure 213 configured for tuning the waveguide 207.

Further aspects of periodic poling described in reference to FIGS. 4B and 4C are set forth in reference to FIG. 5, in which periodic poling is graphically depicted. In one embodiment, poling can be performed with use of an automated probe station that is programmable to precisely position the probes on poling electrodes sequentially and apply two 10-ms-long poling pulses, each reaching a peak voltage of 480V [38-40]. The poling station can be equipped with a two-dimensional precision control stage (Newport model 8742) for alignment of the sample in the X and Z directions, complemented by two three-dimensional translational stages that position the probes connected to the positive and negative poling electrodes 209 wherein one of the electrodes (left side of FIG. 5) is provided with finger electrodes dimensions to define the targeted poling regions 206R as set forth in reference to FIG. 4C. During poling, after ensuring proper contact between the first set of poling electrodes 209 and probes, the automated poling process can be set to start, controlled by a LABVIEW program. Under control of the LABVIEW program, the sample stage automatically moves down, advances forward, and moves up to initiate the next poling cycle, until an entire die containing 28 sets of electrodes are poled. This automation facilitates the reliable periodic poling of an entire die (which can be about 1.5 cm×1.5 cm) without manual control or intervention, significantly reducing the workload of wafer-scale periodic poling. After poling, direct SH microscopy or SHG characterization (on patterning of waveguide 207 at the poling region first) can be performed to test the poling quality. In one embodiment, poling can be optimized through substantial experiments by sweeping all the existing poling parameters, including the voltage, pulse number, and the poling period involved.

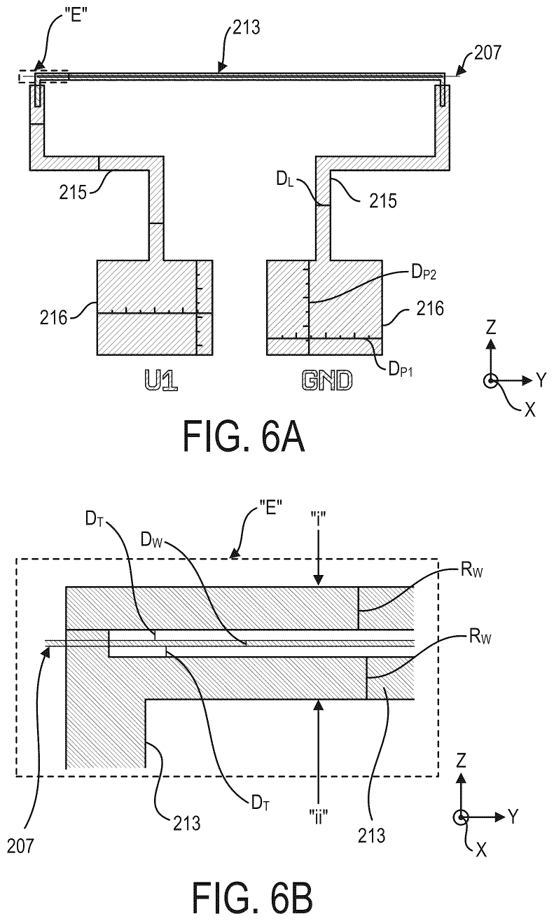

Additional details of tuning structure 213 in one embodiment are shown in FIG. 6A and FIG. 6B. Referring to FIGS. 6A and 6B, tuning structure 213 can be defined by a micro-heater provided by one or more resistive load. On application of a voltage to the one or more resistive load, electrical current flows through the one or more resistive load and the one or more resistive load heats up to direct heat energy toward waveguide 207. FIG. 6B depicts an exploded view E of the section E as shown in FIG. 6A. Referring to FIG. 6B, tuning structure 213 can be defined by first and second elongated resistive loads at “i” and “ii” disposed to run parallel with waveguide 207. Referring to FIG. 6B the first and second elongated resistive loads at “i” and “ii” like waveguide 207 extend in a direction parallel to the Y axis of the depicted reference coordinate system. Both the first and second elongated resistive loads at “i” and “ii” can be offset in the z-direction from waveguide 207. Both the gap between the first and second elongated resistive loads at “i” and “ii” and the waveguide 207 can be set as 2 micrometers, i.e., offset in the Z-direction from waveguide 207, e.g., by about 2.0 micrometers according to one embodiment, and in another embodiment, from about 0.0 micrometers to about 10.0 micrometers or greater.

In the embodiment depicted on FIG. 6B, the first and second elongated resistive loads at “i” and “ii” can be spaced apart at an equal distance from an imaginary plane extending parallel to the X-Y reference plane that encompasses a center axis of waveguide 207. On application of voltage to the first and second resistive loads, electrical current flows through the first and second resistive loads so that the first and second elongated resistive loads direct heat to waveguide 207. For application of voltage to tuning structure 213, ferroelectric crystal wafer 200 can include conductive lines 215 and conductive pads 216. Conductive pads 216 configured for receipt of voltage source loads can include a positive conductive pad electrode and a negative conductive pad electrode. In one embodiment, the first and second elongated resistive loads at “i” and “ii” can be formed of NiCr, which can feature an electrical resistivity of about 0.688 μΩ-cm (Area=5 um*0.25 um, R=640 Ohm, l=1.1625 mm). In another aspect, conductive lines 215 and conductive pads 216 can be formed of Au or other conducting material with low resistivity.

In one embodiment, conductive lines 215 can include a linewidth, D_{L}, of about 50 μm and conductive pads 216 can include dimensions, D_{P1}×D_{P2}, of about 400×330 μm. Referring to the exploded view of FIG. 6B, waveguide 207 can include a top width, D_{W}, of about 0.9 to about 1.2 μm, and the elongated resistive loads at “i” and “ii” can be offset from waveguide 207 in the z direction by an offset distance, D_{T}, of about 2.0 μm, and the width R_{W} of each elongated resistive load at “i” and “ii” can be about 8.0 μm. In one embodiment, the offset distance between the segmented NiCr micro-heater defining tuning structure 213 in the embodiment of FIGS. 6A and 6B and waveguide 207 can be selected to keep the balance of maximizing heating efficiency while minimizing the light propagation absorption. In reference to, e.g., FIGS. 2-3, FIGS. 4E-4F, and FIGS. 6A-6B there is set forth herein, according to one embodiment, a photonic structure 100, 200 comprising: a substrate; a waveguide 207 formed over the substrate; an insulator layer 210 formed over the waveguide, wherein the waveguide is formed of nonlinear optical material; and a tuning structure 213 integrally formed on the photonic structure with the waveguide 207, the tuning structure 213 configured for tuning the waveguide 207, wherein the nonlinear optical material is periodically poled lithium niobate, wherein the photonic structure includes a plurality of tuning structures 213 including the tuning structure 213, wherein the plurality of tuning structures are defined by respective segmented micro-heaters that are configured to apply heat energy at different sections along the propagation direction of the waveguide, wherein the respective segmented micro-heaters are of about equal length, and wherein adjacent ones of the respective micro-heaters are about evenly spaced, and wherein the respective micro-heaters are provided by elongated resistive loads that radiate heat on application of voltage thereto, wherein the respective micro-heaters are configured so that, on applying different DC voltage to the respective micro-heaters, the respective micro-heaters can change a dimension of the waveguide 207 including one or more of film thickness, width or etch depth, thus changing the corresponding QPM wavelength of the TF-PPLN waveguide.

Tuning of waveguides 207 can be performed on a multiple device basis wherein multiple waveguides are tuned simultaneously or on a single device basis wherein a single waveguide can be tuned independently. Tuning can be performed on a wafer-scale during wafer-scale fabrication prior to cleaving and dicing of ferroelectric crystal wafer 200 and/or on a chip scale after cleaving and dicing or otherwise finishing of ferroelectric crystal wafer 200. Tuning can be performed by a supplier (e.g., manufacturer and/or packager) and/or end-user that integrates one or more photonic chip 100 in a finished product.

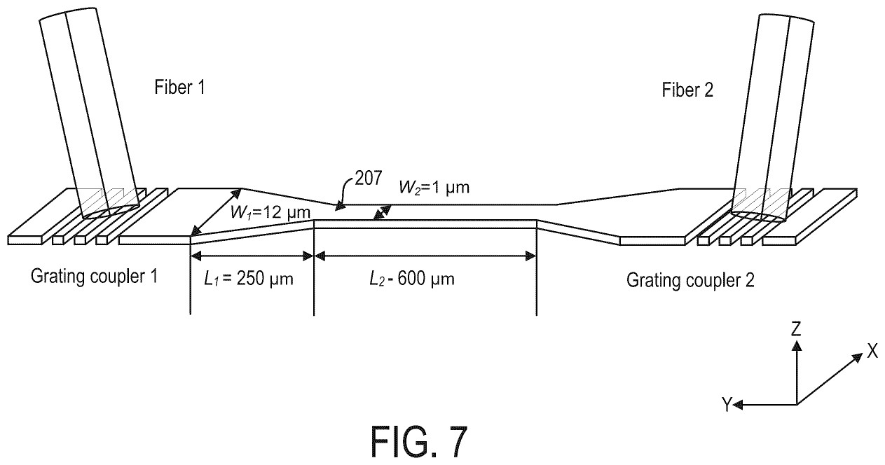

A structure for use in simultaneously tuning multiple waveguides on a wafer-scale is shown in FIG. 7. FIG. 7 is a grating structure for vertically coupling light into waveguide 207. The grating structure of FIG. 7 can be configured to couple light into waveguides 207 of multiple device regions throughout ferroelectric crystal wafer 200 simultaneously. For example, with light coupled into a waveguide 207 of each photonic device region such as 101A, 101B or 101C of ferroelectric crystal wafer 200, heating power of each tuning structure 213 defining a micro-heater can be set to 50% the maximum capacity to establish a baseline for tuning. By monitoring the QPM spectrum change when increasing/decreasing the power on each micro-heater, there can be obtained the qualitative tuning trend for each heater, which facilitates coarse alignment with the most prominent QPM peaks. Fine tuning and optimizing the QPM spectrum can then be performed by iteratively adjusting the powers on each tuning structure 213 defining a micro-heater to achieve a single-main-peak QPM spectrum, e.g., as shown by inset (b) of FIG. 1. The inset 1(b) depicts a single main peak with minor peaks of less than about 0.1 of the highest normalized conversion efficiency. The described tuning process can provide QPM spectrum refinement nonlinear conversion efficiency enhancement by addressing the inhomogeneous broadening of the quasi-phase matching (QPM) spectrum induced by film thickness variations across the wafer. An instance of the grating structure as depicted in FIG. 7 can be provided for each photonic device region such as photonic device regions 101A-101C of ferroelectric crystal wafer 200, i.e., for every input and output port of light.

Tuning of multiple waveguides 207 simultaneously can facilitate coordination of the respective QPM spectrums of the multiple waveguides 207 so that targeted spectrum characteristics of an application can be achieved. When multiple waveguides are tuned simultaneously, the various QPM spectrums of the respective waveguides 207 can be tuned for elimination of sidelobes as set forth herein so that the QPM spectrum of each respective waveguide 207 features a single dominant peak. Additionally or alternatively for spectrum coordination, when multiple waveguides are tuned simultaneously, the various QPM spectrums of the respective waveguides 207 can be tuned so that the peak wavelength of the QPM spectrum of the respective waveguides 207 is matched. Additionally or alternatively for spectrum coordination, when multiple waveguides are tuned simultaneously, the various QPM spectrums of the respective waveguides 207 can be tuned so that the peak wavelength of the QPM spectrum of the respective waveguides 207 are intentionally tuned to different targeted wavelengths depending on targeted performance attributes of a particular application. In one embodiment, tuning can be performed so that the first to Nth QPM spectrum peaks of waveguides 207 are staggered for satisfaction of targeted performance attributes of a particular application, e.g. multiple channel data transmission.

In one embodiment, enhancing the tuning efficiency of waveguides 207 on a wafer-scale can be performed with ferroelectric crystal wafer 200 in the intermediary stage of fabrication depicted in FIG. 4F, i.e., with air trenches 214 formed. Air trenches 214 can improve thermal efficiency. Tuning on a wafer-scale prior to dicing and cleaving or otherwise finishing processing of ferroelectric crystal wafer 200 for production of photonic chip 100 can be performed using the multiple device tuning process as set forth in reference to FIG. 7. With light coupled into the waveguide 207 of each photonic device region 101A-101C of ferroelectric crystal wafer 200, heating power of each tuning structure 213 defining a micro-heater can be set to 50% the maximum capacity to establish a baseline for tuning. By monitoring the QPM spectrum change when increasing/decreasing the power on each micro-heater, there can be obtained the qualitative tuning trend for each heater, which facilitates coarse alignment with the most prominent QPM peaks. Fine tuning and optimizing the QPM spectrum can then be performed by iteratively adjusting the powers on each tuning structure 213 defining a micro-heater to achieve a single-main-peak QPM spectrum.

Subsequent to cleaving and dicing of ferroelectric crystal wafer 200 for production of photonic chip 100, tuning of waveguides 207 can be performed on chip scale, i.e., with respect to one or more produced photonic chip 100 (e.g., FIG. 2 and FIG. 3). Embodiments herein recognize that waveguiding layer 206 can be expected to deform to its pre-tuned state responsively to tuning structure 213 being de-energized. Accordingly, embodiments herein recognize that retaining the tuning structure 213 on respective formed photonic chips 100 produced by cleaving and dicing or otherwise finishing processing of ferroelectric crystal wafer 200 can facilitate tuning of waveguide 207 after photonic chip 100 is provided to an end user for use in a production environment.

With light coupled into a waveguide 207 of a photonic chip 100, heating power of each tuning structure 213 defining a micro-heater can be set to 50%, the maximum capacity to establish a baseline for tuning. By monitoring the QPM spectrum change when increasing/decreasing the power on each micro-heater, there can be obtained the qualitative tuning trend for each heater, which facilitates coarse alignment with the most prominent QPM peaks. Fine tuning and optimizing the QPM spectrum can then be performed by iteratively adjusting the powers on each tuning structure 213 defining a micro-heater to achieve a single-main-peak QPM spectrum (e.g., as shown in FIG. 1, inset (b), where a single peak exceeds an efficiency amplitude threshold).

In one embodiment, an automated control algorithm for optimizing tuning parameters can be designed for the end user of photonic chip 100 produced by cleaving and dicing or otherwise finishing processing of ferroelectric crystal wafer 200 as shown in FIG. 4E. Through the feedback from the detected photo detector (PD) spectrum and subsequent calculations of the designed automated control algorithm, the corresponding tuning parameters can be dynamically generated based on the real condition of each fabricated waveguides 207, e.g., TF-PPLN devices, specifically accounting for its overall thickness variation, which can benefit achieving optimal quasi phase matching and nonlinear conversion efficiency.

As set forth herein, the tuning of waveguides 207 with use of one or more tuning structure 213 can be performed on a wafer-scale and/or on a chip scale.

In one use case, wafer-scale tuning is not performed, and only chip scale tuning is performed, e.g., by an end user. In another use case, only wafer-scale tuning is performed, without performing chip scale tuning. In another use case, there can be performed both wafer-scale tuning and chip scale tuning. According to one example, wafer-scale tuning can be performed by a manufacturer to provide a preliminary test for purposes of guaranteeing the working performance of both waveguides 207 and tuning structures 213, and chip scale tuning can be performed by the end user that integrates one or more photonic chip 100 into a finished product where the finished product includes power sources with pre-set power combination for tuning structures 213. In one use case, tuning can be performed only by a user that integrates one or more photonic chip 100 in a finished product, but not by a supplier (e.g., manufacturer and/or packager). In one use case, tuning can be performed only by a provider but not a user that integrates one or more photonic chip 100 into a finished product. In one use case, tuning can be performed by both a provider and a user that integrates one or more photonic chips into a finished product. According to one example, tuning can be performed by a provider (e.g., a fabricator and/or fabricator) to produce a preliminary test for purposes of guaranteeing the working performance of both waveguides 207 and tuning structures 213, and tuning can be performed by a user that integrates one or more photonic chip 100 into a finished product, where the finished product includes a power source for persistently powering tuning structures 213.

In either the case of case of wafer-scale tuning or chip-scale tuning, embodiments herein can benefit from a manufacturer performing a preliminary test of each waveguide 207 and its tuning structure 213, to verify their good working performance. Then, manufacturers deliver the optimized DC source power parameter combinations of each segmented microheater defining a tuning structure 213 and the finalized product together to the end users, to make sure that the end user can perform the optimization of the QPM spectrum of every photonic device, either integrated on the photonic chips 100 (whether the photonic chips 100 are non-wafer-scale or wafer scale) with use of the parameters provided by the manufacturers.

In one aspect, wafer-scale processing can facilitate delivery of photonic chip 100 configured as a pre-tuned chip to an end user, i.e., with preliminary test the optimized DC source power parameters will be provided by the manufacturer to the end user for convenience. In one aspect, wafer-scale tuning can facilitate simultaneous tuning of multiple waveguides 207 wafer-scale, which can benefit a variety of application in complex photonic systems such as quantum computing. Embodiments herein recognize that where an application involves use of a photonic chip 100 having multiple waveguides 207, e.g., wherein photonic chip 100 is configured as wafer-scale photonic chip, or otherwise as a photonic chip 100 having multiple waveguides 207, the application can benefit from a wafer-scale tuning process wherein multiple waveguides 207 can be tuned simultaneously. Tuning of multiple waveguides 207 simultaneously can facilitate the coordination of the respective QPM spectrums of the multiple waveguides 207 so that targeted spectrum characteristics of an application can be achieved. Where an application includes use of a photonic chip 100 including multiple waveguides 207 that have been tuned with use of wafer-scale tuning, photonic chip 100 can have integrally fabricated therein a built-in power source 211 configured to persistently deliver the derived tuning voltages to tuning structures 213 as derived with use of wafer-scale tuning. Alternatively, packaging associated to photonic chip 100 can be configured to persistently deliver the derived tuning voltages. Chip scale tuning of photonic chip 100 can facilitate delivery of photonic chip 100 to an end user in a form without tuning voltages persistently applied to the one or more tuning structure 213 of the photonic chip 100 during the delivery.

As noted, in either the case of case of wafer-scale tuning or chip-scale tuning, embodiments herein can benefit from a manufacturer performing a preliminary test of each waveguide 207 and its tuning structure 213, to verify their good working performance. Then, manufacturers deliver the optimized DC source power parameter combinations of each segmented microheater defining a tuning structure 213 and the finalized product together to the end users, to make sure that the end user can perform the optimization of the QPM spectrum of every photonic device, either integrated on the photonic chips 100 (whether the photonic chips 100 are non-wafer-scale or wafer scale) with use of the parameters provided by the manufacturers.

There is set forth herein according to one embodiment, periodically poling, in respective device regions 101A-101C of a ferroelectric crystal wafer 200, a waveguiding material layer 206 to impose alternatingly poled regions on the waveguiding material layer 206, wherein the waveguiding material layer 206 is formed of nonlinear optical material; patterning, in respective ones of the device regions 101A-101C, the waveguiding material layer 206 to define a waveguide 207; and fabricating in respective ones of the device regions 101A-101C, at least one tuning structure 213 for tuning a quasi-phase matching (QPM) spectrum of the waveguide, wherein the nonlinear optical material is lithium niobate that defines periodically poled lithium niobate subsequent to the periodically poling, wherein the method includes forming, in respective ones of the device regions 101A-101C, electrodes 209 for use in performing the periodic poling, applying a voltage to the electrodes 209 to apply an electric field to the waveguiding material layer 206, removing the electrodes prior to the fabricating, wherein the fabricating, in respective ones of the device regions 101A-101C, at least one tuning structure 213 for tuning a spectrum of the waveguide 207 includes fabricating a plurality of micro-heaters for tuning the waveguide in the respective device regions, wherein the method includes for at least one device region of the device regions 101A-101C, tuning the QPM spectrum of the waveguide, wherein the tuning includes iteratively adjusting applied voltage applied to each micro-heaters along the waveguide until the QPM spectrum of the waveguide of the at least one device region features a single dominant peak.

Additional features and advantages of embodiments herein are set forth with reference to the following examples.

### Example 1

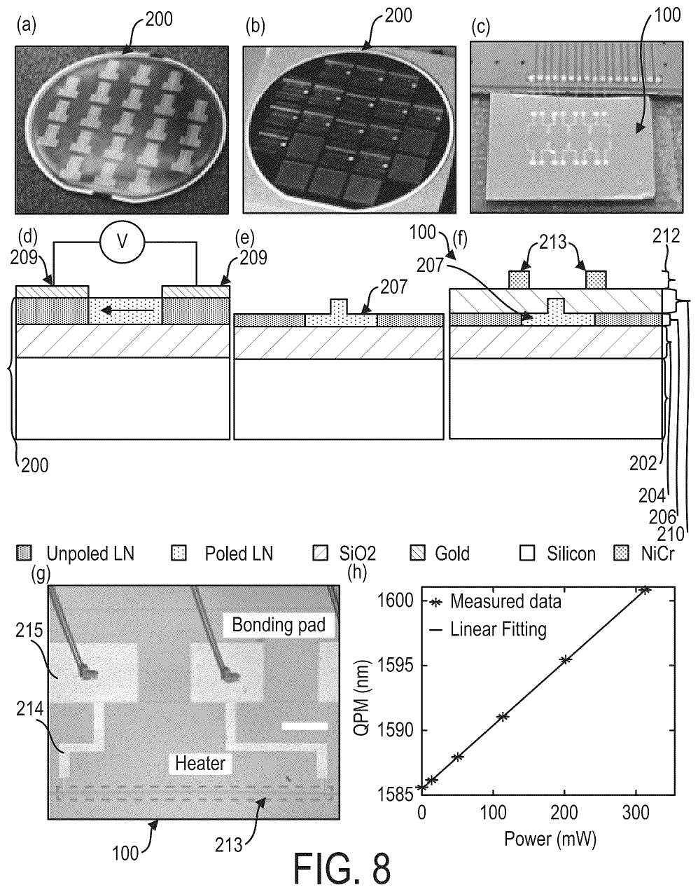

Wafer-scale fabrication of photonic chips 100 that include photonic TF-PPLN devices in accordance with the method of FIGS. 4A-4F can be performed with use of implementation details set forth in FIG. 8.

A photonic chip 100 provided by the photonic chip of FIG. 8 inset (f) is fabricated on ferroelectric crystal wafer 200 provided by a commercial 4-inch LNOI wafer supplied by NANOLN Ltd., comprising a waveguiding layer 206 provided by a 600 nm MgO-doped LN thin-film layer, insulator layer 204 provided by a 2 μm oxide buffer layer, and substrate 202 provided by a 500 μm silicon substrate. Firstly, electrodes 209 provided by poling finger electrodes are patterned using an i-line UV stepper lithography (ASML), followed by thermal evaporation of nichrome (NiCr) and gold (Au) and a standard lift-off process, as shown in FIG. 8 inset (a). Secondly, for application of poling voltages a home-built automated probe station that is programmable to precisely position the probes on the poling electrodes sequentially and apply the necessary poling voltage pulses [35-37]. This automation facilitates the reliable periodic poling of an entire 1.5 cm×1.5 cm die without manual control or intervention, significantly reducing the workload of wafer-scale periodic poling. Thirdly, after removal of all metal electrodes in accordance with fabrication processing set forth in FIG. 4D, a second aligned stepper lithography is carried out to define the patterns of waveguides 207 provided by optical waveguides in the poled regions. The exposed photoresist patterns are then transferred to the LN layer using a reactive ion etching (RIE) process [FIG. 8 inset (b)]. Subsequently, the fabricated TF-PPLN waveguides are clad in insulator layer 210 provided by silicon dioxide (SiO₂) using a plasma-enhanced chemical vapor deposition (PECVD) system. Fourthly, another two aligned photolithography processes are employed to fabricate tuning structures 213 provided by NiCr heaters in the vicinity of the optical waveguides, as well as terminations provided by conductive lines 215 and conductive pads 216 for wire bonding, similar to the process described in Ref. [26]. Conductive lines 215 and conductive pads 216 can be formed of Au. Finally, the fabricated wafer-based structure undergoes cleaving and facet polishing to ensure good end-fire optical coupling. The Au electrode pads, consisting of 4 or 8 pairs of anodes and cathodes, are wire-bonded to a printed circuit board (PCB) to facilitate independent control of each segmented micro-heater [FIG. 8 inset (c)]. The full device fabrication flow is illustrated in the cross-sectional schematics in FIG. 8 insets (d)-(f). The gap between adjacent micro-heaters is 100 μm and the resistance of the 1.425-mm (for 6 mm-long PPLN) and 1.1625-mm (for 1 cm-long PPLN) long heaters is ˜1000Ω and ˜640Ω, respectively. During testing over several days, no significant change or damage to the heaters or the wire bonds at heating powers up to 1.5 W was observed.

FIG. 8 inset (g) shows a close-up microscope image of the fabricated segmented micro-heaters. To evaluate the tuning efficiency of the fabricated segmented micro-heaters, uniformly increasing DC currents was applied simultaneously to all electrodes. As depicted in FIG. 8 inset (h), the peak QPM wavelength exhibits a red shift in response to the incremental heating power, which indicates a thermal tuning efficiency of 50 pm/mW, which could be further improved by reducing the thermal power leakage using a suspended structure [26]. Additional features are realized through the techniques set forth herein. Other embodiments and aspects, including but not limited to methods, computer program product and system, are described in detail herein and are considered a part of the claimed invention. Referring to FIG. 8, there is shown in inset (a) the fabricated 4-inch LNOI wafer patterned with finger electrodes for periodic poling; in inset (b) the wafer after periodic poling and patterning of optical waveguides; in inset (c) the final cleaved TF-PPLN chip wire-bonded to a PCB; in inset (d-f) cross-sectional schematics of the fabrication process flow, specifically in inset (d) high voltage poling; (e) optical waveguide formation using RIE etching; and in inset (f) fabrication of the segmented micro-heaters. In inset (g) there is shown a close-up microscope image of the fabricated segmented micro-heaters. Scale bar: 5 mm. In inset (h) there is shown measured QPM wavelength as a function of increasing heating power.

### [End of Example 1]

Recovery of distorted QPM spectra with use of tuning processes herein is set forth in reference to Example 2 and 3.

### Example 2

Samples of photonic chips provided by TF-PPLN devices were fabricated according to the method of FIGS. 4A-4F Example 1, and in accordance with previous work [2], targeted second-harmonic generation (SHG) from telecom to near-visible bands.

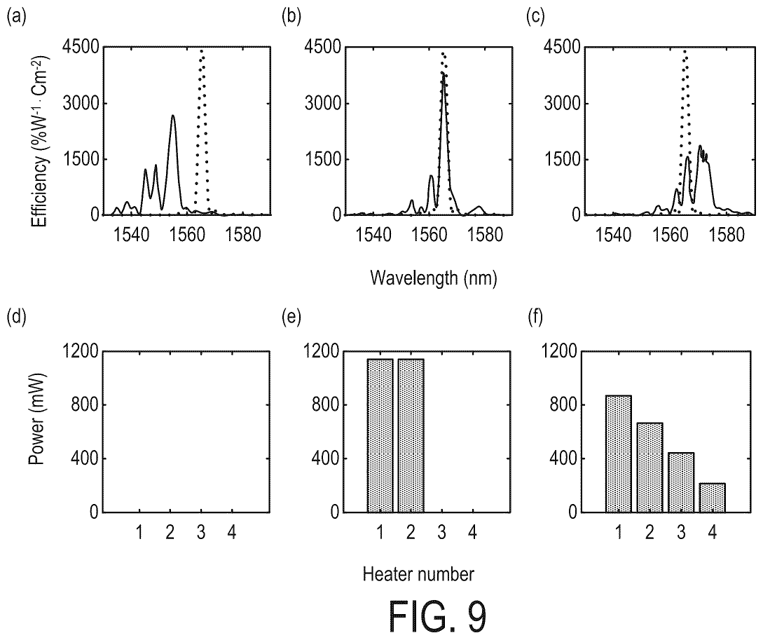

A telecom tunable light source (SANTEC TSL-550) was coupled into and out of the fabricated devices utilizing two optical lensed fibers. A fiber polarization controller was used to maintain a fundamental transverse-electric (TE) mode input. The measured SHG efficiency as a function of pump wavelength, also known as the QPM spectrum, was acquired by sweeping the input wavelength and simultaneously recording the output SHG power using a visible-band photodetector (NEWPORT 1801). The on-chip SHG efficiency is obtained by carefully calibrating and de-embedding the visible and telecom coupling losses of the chip. For a 6 mm long device in FIG. 9 inset (a), the QPM profile without thermal tuning features three dominant peaks at 1545.1 nm, 1548.8 nm and 1554.9 nm.

DC currents were subsequently applied to the four segmented micro-heaters integrated with this TF-PPLN waveguide. Heating power of each micro-heater was first set to 50% the maximum capacity to establish a baseline for tuning. By monitoring the QPM spectrum change when increasing/decreasing the power on each micro-heater, the qualitative tuning trend for each heater was obtained, which facilitated coarse alignment of the most prominent QPM peaks. The QPM spectrum was then fine-tuned and optimized by iteratively adjusting the powers on each micro-heater [FIG. 9 inset (e)] to achieve a single-main-peak QPM spectrum as depicted in FIG. 9 inset (b).

The measured peak second-harmonic (SH) conversion efficiency after thermal tuning was 3802% W⁻¹cm⁻², which increased by 32% the initial value (2878% W⁻¹cm⁻²) and corresponds to 84% the theoretical conversion efficiency (4500% W⁻¹cm⁻²). The remaining minor discrepancy from an ideal efficiency is mainly attributed to the small sub-peak at 1560.9 nm, which could not be merged into the main SHG peak in this particular set of device, possibly due to a larger thickness variation than expected at certain location of the chip.

The measured on-chip SHG efficiency for the device was 1153% W⁻¹cm⁻² at optimized thermal tuning parameters (734% W⁻¹cm⁻² before tuning). This value is ˜68% that of a device without inhomogeneous broadening (1700% W⁻¹cm⁻²), estimated by assuming the area underneath the QPM spectrum is invariant for inhomogeneous broadening. The remaining discrepancy from the simulated conversion efficiency is mainly due to insufficient poling depths in this 1-cm PPLN waveguides, which were fabricated from earlier, less optimized batch of TF-PPLN production. We also note that the areas beneath the QPM transfer functions before and after thermal tuning are consistent in both devices.

In FIG. 9 insets (a-c) there are depicted measured SHG intensities as functions of pump wavelengths for a 6 mm TF-PPLN waveguide before applying tuning currents (a), after optimization of the heater powers (b), and with an arbitrary set of tuning parameters (c). Insets (d-f) depict DC powers applied to each segmented micro-heater for the scenarios in (a-c) respectively.

### [End of Example 2]

Results of tuning and testing a longer device are set forth in Example 3.

### Example 3

A photonic chip 100 provided by a TF-PPLN device chip was fabricated according to the method of FIGS. 4A-4F, Example 1, and in accordance with previous work [2], targeting second-harmonic generation (SHG) from telecom to near-visible bands.

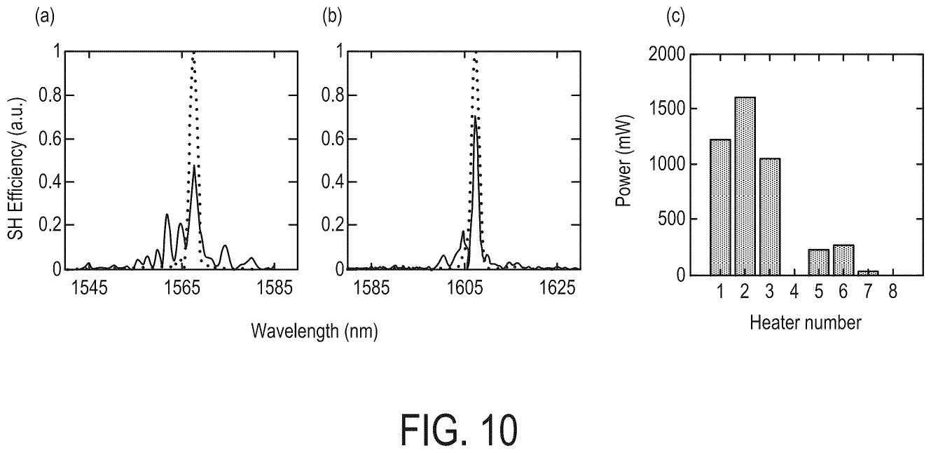

Fabricating and testing was performed on a 1 cm long TF-PPLN optical waveguide with 8 segmented micro-heaters, which ideally features a higher absolute conversion efficiency but is more prone to film thickness variations. As shown in FIG. 10 inset (a), before the thermal tuning of micro-heaters, the QPM spectrum exhibits many unwanted sidelobes, which degrades the SHG conversion efficiency from the ideal value. Similar to the case above, by applying appropriate DC powers [as indicated in FIG. 10 inset (c)], a 57% enhancement of peak SH conversion efficiency was achieved, with significantly suppressed sidelobes, as the measured QPM spectrum in FIG. 10 inset (b) shows. By carefully calibrating the visible and telecom coupling losses of the chip, on-chip SHG efficiency of 1153%/W was estimated for the device with optimized thermal tuning parameters (734%/W before tuning).

FIG. 10 in reference to insets (a-b) depicts measured SHG intensities as functions of pump wavelengths for a 1 cm TF-PPLN waveguide before (a) and after (b) applying tuning currents. Inset (c) depicts DC powers applied to each segmented micro-heater for the scenario depicted in inset (b).

### [End of Example 3]

Simulation results are set forth in Example 4

### Example 4

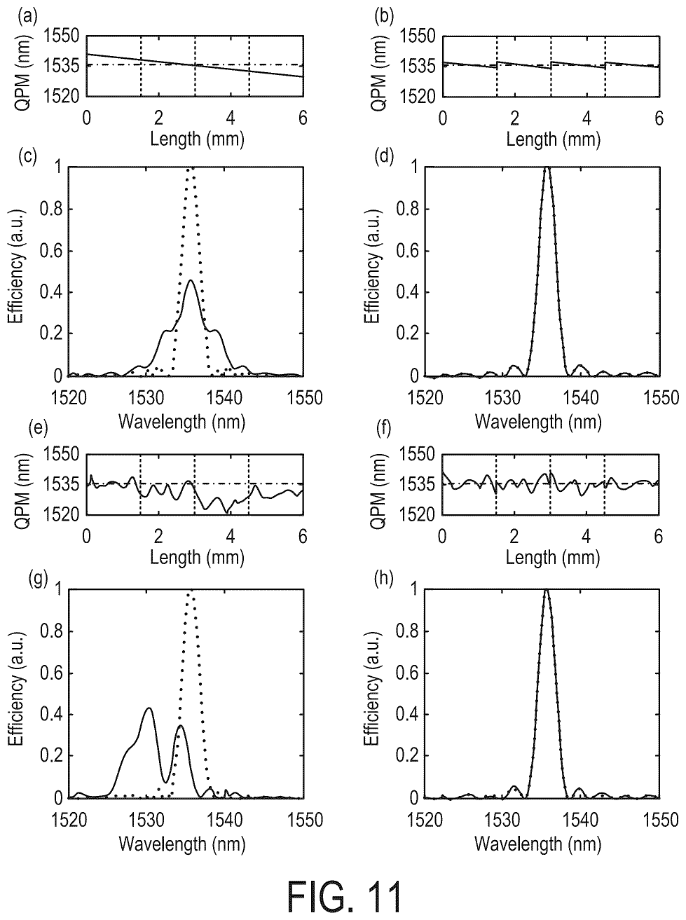

QPM spectra with thickness variation and QPM spectra after optimized local thermal tuning were simulated, as illustrated in FIG. 11. Two scenarios were considered: i) a hypothetical scenario where the film thickness linearly increases from the input to the output port; ii) a realistic scenario based on actually mapped thickness data from our recent research. In the first case, the film thickness linearly increases from 600 nm to 602 nm over a 6-mm device length, which corresponds to a linearly chirped peak QPM wavelength from 1529 nm to 1541 nm, as shown in FIG. 11 inset (a). This leads to significant degradation in the peak conversion efficiency and deviation from the ideal QPM spectrum [FIG. 11 inset (c), dashed curve denotes the ideal spectrum]. However, when this inhomogeneously broadened TF-PPLN waveguide is equipped with four segmented TO tuning modules that align the center QPM wavelengths in each section [FIG. 11 inset (b)], the normalized conversion efficiency is restored to 98% of the ideal value with a nearly perfect QPM spectrum, as shown in FIG. 11 inset (d). To investigate the performance of the segmented tuning scheme in a more realistic scenario (second case), mapped thickness data from the previous study [FIG. 11 inset (e)] [17] was referenced, which lead to a multi-peak QPM spectrum with a peak conversion efficiency ˜45.2% of the ideal case [FIG. 11 inset (g)]. Similar to the first case, by aligning the local film thickness using micro-heaters, the normalized conversion efficiency can be enhanced by a factor of ˜2.2, to 97% of the ideal case, as shown in FIG. 11 inset (h). Moreover, the QPM spectrum is successfully recovered to a single main peak with a standard sinc profile.

FIG. 11 depicts simulated QPM spectra with (right column) and without (left column) segmented thermal tuning in the cases of linearly increasing film thickness as depicted in insets (a)-(d) and a realistic thickness profile as depicted in insets (e)-(h). Insets (a) and (e) show the local QPM wavelengths along the TF-PPLN waveguides compared with the target QPM wavelength (dashed). Insets (c) and (g) correspond to the simulated QPM spectra in comparison with the ideal QPM spectrum (dashed). Insets (b) and (f) show the local QPM wavelength distributions after the center QPM wavelengths in each section are aligned by the segmented micro-heaters. Insets (d) and (h) show the corresponding recovered QPM spectra by the micro-heaters.

### [End of Example 4]

Embodiments herein provide a wafer-scale TF-PPLN nonlinear photonic platform, leveraging ultraviolet stepper lithography and an automated poling process. To address the inhomogeneous broadening of the quasi-phase matching (QPM) spectrum induced by film thickness variations across the wafer, embodiments herein provide segmented thermal optic tuning modules that can precisely adjust and align the QPM peak wavelengths in each section. Using the segmented micro-heaters, embodiments herein provide realignment of inhomogeneously broadened multi-peak QPM spectra with more than doubled peak second-harmonic generation efficiency. Using the segmented micro-heaters, there is demonstrated the successful realignment of inhomogeneously broadened multi-peak QPM spectra with up to 57% enhancement of conversion efficiency. In one demonstration, a high normalized conversion efficiency of 3802% W⁻¹cm⁻² in a 6 mm long PPLN waveguide was achieved, recovering 84% of the theoretically predicted efficiency in this device.

The advanced fabrication techniques and segmented tuning architectures provide wafer-scale integration of complex functional nonlinear photonic circuits with applications in quantum information processing, precision sensing and metrology, and low-noise-figure optical signal amplification.

Thin-film periodically poled lithium niobate (TF-PPLN) devices, renowned for their strong optical nonlinearity and excellent light confinement, are expected to serve as nonlinear photonic building blocks for the next generation of optical communication and quantum information processing systems [1]. Due to the substantially enhanced optical intensity in tightly confined waveguides, TF-PPLN wavelength convertors exhibit more than one order of magnitude higher normalized conversion efficiencies compared to their bulk counterparts [2-4]. These highly efficient TF-PPLN waveguides have enabled many high-performance nonlinear devices, including resonator-based ultra-efficient wavelength converters [5,6], broadband optical parametric amplifiers [7,8] and entangled photon-pair sources [9,10]. Moreover, TF-PPLN devices enjoy excellent compatibility with other on-chip functional photonic devices available on the thin-film lithium niobate (TFLN) platform, such as integrated EO modulators [11,12], acousto-optic modulators [13], frequency combs [14-16], as well as heterogeneously integrated lasers [17] and photodetectors [18-20]. By now, this integration compatibility has empowered chip-scale nonlinear and quantum photonic systems with unprecedented performances, including efficient quantum squeezers [21,22], femtosecond all-optical switches [23], octave-spanning optical parametric oscillators [24], and integrated Pockels lasers co-lasing at infrared and visible wavelengths [25]. Additionally, to facilitate the active control of quasi-phase-matching (QPM) wavelength, thermally tunable TF-PPLN waveguides with high tuning efficiencies have also been developed [26]. In recent years, wafer-scale fabrication techniques have been developed for TFLN devices with passive or electro-optic functionalities [27]. Embodiments herein can incorporate the above approaches and additional methodologies highlighted herein. This limitation persists mainly due to repeatability and throughput issues of the manual periodic poling processes. It is also technically challenging for a research and development laboratory to reliably achieve high-quality nanoscale poling electrodes and accurate multi-layer alignment on a wafer-scale.

To address the QPM inhomogeneous broadening issue, it has been proposed that by fine-tuning the geometric parameters, an optimal noncritical phase-matching configuration can be achieved, rendering the PPLN waveguide less susceptible to variations in thickness [33]. This method however requires a thicker film of 900 nm and a large etching depth, which is challenging in fabrication and not compatible with other commonly used devices in the TFLN platform. More recently, a novel approach has been introduced that leverages pre-fabrication mapping of the film thickness to design customized poling electrodes with domain inversion periods that are adapted to the local film thicknesses [34]. This method effectively suppresses the QPM inhomogeneous broadening and enables a record-high overall conversion efficiency of 10,000% W−1 for PPLN waveguides [34]. However, this technique relies on time-consuming two-dimensional thickness mapping and requires a unique poling electrode design for each chip, thus still face challenges in achieving high-throughput and cost-effective fabrication of future TF-PPLN nonlinear photonic circuits. Embodiments herein can incorporate the above approaches and additional methodologies highlighted herein.

Embodiments herein recognize that challenges to photonic device fabrication include repeatability and reliability of poling processes as well as distortion of QPM spectra at extended PPLN waveguide lengths, since TF-PPLN waveguides are highly sensitive to variations in the optical waveguide dimensions due to their strong geometric dispersion. Among various factors, e.g., etching depth, top width and film thickness [28-31], embodiments herein recognize that film thickness variation is the predominant cause for the QPM spectrum degradation in TF-PPLN, which often leads to broadened or multi-peak QPM profiles and decreased conversion efficiencies [32]. Embodiments herein recognize that for 600 nm thick MgO-doped TF-PPLN waveguides, the QPM peak wavelength for second-harmonic generation (SHG) shifts by 6 nm when the film thickness changes by merely 1 nm. This is particularly problematic for a wafer-scale process where the film thickness variation across a lithium niobate on insulator (LNOI) wafer is typically ±10 nm, leading to significant distortion of the QPM spectrum within each PPLN device and inconsistent peak QPM wavelengths across different PPLN devices in a larger nonlinear photonic circuit.

Embodiments herein provide a wafer-scale TF-PPLN nonlinear photonic platform with segmented thermal-optic (TO) tuning modules. Embodiments herein demonstrate reliable fabrication of TF-PPLN devices on a 4-inch TFLN wafer utilizing ultraviolet stepper lithography and an automated poling process. To counteract the inhomogeneous broadening effects resulting from film thickness variations across the wafer, embodiments herein provide segmented micro-heaters that are capable of locally fine-tuning and aligning the QPM spectral peaks within each individual sections to achieve optimal wavelength conversion efficiencies. Embodiments herein provide recovery of a sinc-like QPM spectrum, with up to 108% improved peak SHG efficiency compared with the as-fabricated devices.

Referring again to FIG. 1, FIG. 1 illustrates ferroelectric crystal wafer 200 and a resulting photonic chip 100 built on ferroelectric crystal wafer 200. FIG. 1 presents a conceptual schematic of a wafer-scale nonlinear photonic platform based on waveguides 207 provided by TF-PPLN waveguides integrated with tuning structures 213 provided by segmented TO tuning modules. Without micro-heaters, the QPM spectra of TF-PPLN waveguides typically see broadened or multi-peak profiles due to variations in film thickness and other geometric parameters (e.g., etching depth or top width), as shown in FIG. 1 inset (b). By individually controlling the thermal power applied to each micro-heater [FIG. 3], we can precisely adjust and align the QPM peaks to converge on the desired target peak wavelength, as shown in FIG. 1 inset (b). The segmented micro-heaters essentially fine tune the film thickness in each section to enhance the global flatness of the TF-PPLN chip. Under this circumstance, the peak conversion efficiency of the PPLN waveguides could be recovered to approach the ideal level, depending on the remaining un-compensated film thickness variations. Referring again to photonic structure 10 of FIG. 1, according to one embodiment, photonic structure 10 of FIG. 1 can include N tuning structures 213 provided by N micro-heaters distributed for tuning of different sections of waveguide 207 along a length of waveguide 207. In a further aspect, the various tuning structures 213 provided by micro-heaters disposed along a length of waveguide 207 can include respective lengths that are about equal. In a further aspect, spacing distances between the various tuning structures 213 provided by micro-heaters disposed along a length of waveguide 207 can be about equal. The micro-heaters defining tuning structures 213 as shown in FIG. 1 can be provided in accordance with the design parameters set forth in reference to FIGS. 6A and 6B.

Embodiments herein demonstrate the wafer-scale production of waveguides including TF-PPLN optical waveguides leveraging UV stepper lithography and an automated poling probe station. Embodiments herein address the degradation of conversion efficiency due to inhomogeneous film thickness by employing a segmented thermal tuning scheme. Embodiments herein demonstrate the successful recovery of single-peak QPM spectral profiles with up to 57% enhancement of the peak conversion efficiency and achieve a highest normalized conversion efficiency of 3802% W⁻¹cm⁻² in a 6 mm long device. Importantly, this is achieved without the need of pre-fabrication thickness mapping or design compensation, which is highly appealing for high-volume and low-cost wafer-scale production. Thermal tuning efficiency can be further enhanced by incorporating local air trenches to minimize heat leakage [26]. LNOI wafers with improved initial thickness variations can be expected to reduce the required heating powers in our devices. In one embodiment, the segmented heater design herein, wherein tuning structures 213 are defined by micro-heaters can be combined with the adaptive poling method to compensate for the remaining inhomogeneous broadening effects and facilitate active tuning of QPM wavelengths.

Embodiments herein show the successful recovery of single-peak QPM spectral profiles with up to 108% enhancement of the peak conversion efficiency without the need of pre-fabrication thickness mapping or design compensation, which is highly appealing for high-volume and low-cost wafer-scale production. The thermal tuning efficiency can be further enhanced by incorporating local air trenches to minimize heat leakage [26]. Even higher peak conversion efficiencies and improved QPM spectral shapes can be achieved by implementing more thermal tuning modules and an automated control algorithm for optimizing the tuning parameters. An automated control algorithm can enable faster searching for optimal working points, simultaneous control over multiple TF-PPLN devices, and real-time adaptation to environmental drifts. The scalable fabrication and tuning methodologies presented herein facilitate large-scale nonlinear photonic integrated circuits with high efficiencies, versatile functionalities, and excellent reconfigurability, unlocking new opportunities for future quantum and classical photonic applications. The terminology used herein is for the purpose of describing particular embodiments only and is not intended to be limiting of the disclosure.

As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements but is not limited to possessing only those one or more steps or elements. Likewise, a step of a method or an element of an article that “comprises”, “has”, “includes” or “contains” one or more features possesses those one or more features but is not limited to possessing only those one or more features.

Terms like “obtainable”or “definable”and “obtained”or “defined”are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained”or “defined”as a preferred embodiment.

It should be appreciated that all combinations of the foregoing concepts and additional concepts discussed in greater detail below (provided such concepts are not mutually inconsistent) are contemplated as being part of the subject matter disclosed herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely exemplary. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S. C. § 112(f) unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. If used herein, the terms “substantially”, “approximately”, “about”, “relatively,” or other such similar terms may also refer to no fluctuations, that is, ±0%. It is contemplated that numerical values, as well as other values that are recited herein can be modified by the term “about”, whether expressly stated or inherently derived by the discussion of the present disclosure. Further, any description of a range herein can encompass all subranges.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, physically, optically, etc.) with the other component (notwithstanding the presence of one or more additional components therebetween). It is to be understood that some components that are in direct physical contact with one another may or may not be in electrical contact with one another. Moreover, two components that are electrically connected, electrically coupled, optically connected, optically coupled, may or may not be in direct physical contact, and one or more other components may be positioned therebetween.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description but is only limited by the scope of the appended claims.

All publications cited in this specification are herein incorporated by reference as if each individual publication were specifically and individually indicated to be incorporated by reference herein as though fully set forth.

Where one or more ranges are referred to throughout this specification, each range is intended to be a shorthand format for presenting information, where the range is understood to encompass each discrete point within the range as if the same were fully set forth herein.

While several aspects and embodiments of the present disclosure have been described and depicted herein, alternative aspects and embodiments may be affected by persons having ordinary skill in the art to accomplish the same objectives. Accordingly, this disclosure and the appended claims are intended to cover all such further and alternative aspects and embodiments as fall within the true spirit and scope of the present disclosure.

The following references are incorporated herein by reference in their entireties and a skilled person is considered to be aware of disclosure of these references.

### REFERENCES

1. A. Boes, L. Chang, C. Langrock, M. Yu, M. Zhang, Q. Lin, M. Lončar, M. Fejer, J. Bowers, and A. Mitchell, Science 379, eabj4396 (2023).
2. C. Wang, C. Langrock, A. Marandi, M. Jankowski, M. Zhang, B. Desiatov, M.M. Fejer, and M. Loncar, Optica 5, 1438 (2018).
3. J. Zhao, M. Rüsing, U.A. Javid, J. Ling, M. Li, Q. Lin, and S. Mookherjea, Opt. Express 28, 19669 (2020).
4. A. Rao, K. Abdelsalam, T. Sjaardema, A. Honardoost, G.F. Camacho-Gonzalez, and S. Fathpour, Opt. Express 27, 25920 (2019).
5. J. Lu, J.B. Surya, X. Liu, A.W. Bruch, Z. Gong, Y. Xu, and H.X. Tang, Optica 6, 1455 (2019).
6. J.-Y. Chen, Z.-H. Ma, Y.M. Sua, Z. Li, C. Tang, and Y.-P. Huang, Optica 6, 1244 (2019).
7. L. Ledezma, R. Sekine, Q. Guo, R. Nehra, S. Jahani, and A. Marandi, Optica 9, 303 (2022).
8. M. Jankowski, N. Jornod, C. Langrock, B. Desiatov, A. Marandi, M. Loncar, and M.M. Fejer, Optica 9, 273 (2022).
9. J. Zhao, C. Ma, M. Rüsing, and S. Mookherjea, Phys. Rev. Lett. 124, 163603 (2020).
10. G.-T. Xue, Y.-F. Niu, X. Liu, J.-C. Duan, W. Chen, Y. Pan, K. Jia, X. Wang, H.-Y. Liu, Y. Zhang, P. Xu, G. Zhao, X. Cai, Y.-X. Gong, X. Hu, Z. Xie, and S. Zhu, Phys. Rev. Applied 15, 064059 (2021).
11. C. Wang, M. Zhang, X. Chen, M. Bertrand, A. Shams-Ansari, S. Chandrasekhar, P. Winzer, and M. Loncar, Nature 562, 101 (2018).
12. M. He, M. Xu, Y. Ren, J. Jian, Z. Ruan, Y. Xu, S. Gao, S. Sun, X. Wen, L. Zhou, L. Liu, C. Guo, H. Chen, S. Yu, L. Liu, and X. Cai, Nat. Photonic 13, 359 (2019).
13. L. Wan, Z. Yang, W. Zhou, M. Wen, T. Feng, S. Zeng, D. Liu, H. Li, J. Pan, N. Zhu, W. Liu, and Z. Li, Light Sci Appl 11, 145 (2022).
14. C. Wang, M. Zhang, M. Yu, R. Zhu, H. Hu, and M. Loncar, Nat Commun 10, 978 (2019).
15. Y. He, Q.-F. Yang, J. Ling, R. Luo, H. Liang, M. Li, B. Shen, H. Wang, K. Vahala, and Q. Lin, Optica 6, 1138 (2019).
16. A.W. Bruch, X. Liu, Z. Gong, J.B. Surya, M. Li, C.-L. Zou, and H.X. Tang, Nat. Photonic 15, 21 (2021).
17. C. Op De Beeck, F.M. Mayor, S. Cuyvers, S. Poelman, J.F. Herrmann, O. Atalar, T.P. McKenna, B. Haq, W. Jiang, J.D. Witmer, G. Roelkens, A.H. Safavi-Naeini, R. Van Laer, and B. Kuyken, Optica 8, 1288 (2021).
18. B. Desiatov and M. Lončar, Applied Physics Letters 115, 121108 (2019).
19. X. Guo, L. Shao, L. He, K. Luke, J. Morgan, K. Sun, J. Gao, T.-C. Tzu, Y. Shen, D. Chen, B. Guo, F. Yu, Q. Yu, M. Jafari, M. Lončar, M. Zhang, and A. Beling, Photon. Res. 10, 1338 (2022).
20. S. Zhu, Y. Zhang, Y. Ren, Y. Wang, K. Zhai, H. Feng, Y. Jin, Z. Lin, J. Feng, S. Li, Q. Yang, N. H. Zhu, E.Y.-B. Pun, and C. Wang, Advanced Photonic Research 4, 2300045 (2023).
21. R. Nehra, R. Sekine, L. Ledezma, Q. Guo, R.M. Gray, A. Roy, and A. Marandi, Science 377, 1333 (2022).
22. H.S. Stokowski, T.P. McKenna, T. Park, A.Y. Hwang, D.J. Dean, O.T. Celik, V. Ansari, M. M. Fejer, and A.H. Safavi-Naeini, Nat Commun 14, 3355 (2023).
23. Q. Guo, R. Sekine, L. Ledezma, R. Nehra, D.J. Dean, A. Roy, R.M. Gray, S. Jahani, and A. Marandi, Nat. Photon. 16, 625 (2022).
24. L. Ledezma, A. Roy, L. Costa, R. Sekine, R. Gray, Q. Guo, R. Nehra, R.M. Briggs, and A. Marandi, SCIENCE ADVANCES (2023).
25. M. Li, L. Chang, L. Wu, J. Staffa, J. Ling, U.A. Javid, S. Xue, Y. He, R. Lopez-rios, T.J. Morin, H. Wang, B. Shen, S. Zeng, L. Zhu, K.J. Vahala, J.E. Bowers, and Q. Lin, Nat Commun 13, 5344 (2022).
26. X. Liu, C. Zhang, Y. Pan, R. Ma, X. Zhang, M. Chen, L. Liu, Z. Xie, S. Zhu, S. Yu, and X. Cai, Opt. Lett. 47, 4921 (2022).
27. K. Luke, P. Kharel, C. Reimer, L. He, M. Loncar, and M. Zhang, Opt. Express 28, 24452 (2020).
28. M.M. Fejer, G.A. Magel, D.H. Jundt, and R.L. Byer, IEEE J. Quantum Electron. 28, 2631 (1992).
29. X.-H. Tian, W. Zhou, K.-Q. Ren, C. Zhang, X. Liu, G.-T. Xue, J.-C. Duan, X. Cai, X. Hu, Y.-X. Gong, Z. Xie, and S.-N. Zhu, Chin. Opt. Lett. 19, 060015 (2021).
30. G.-T. Xue, X.-H. Tian, C. Zhang, Z. Xie, P. Xu, Y.-X. Gong, and S.-N. Zhu, Chinese Phys. B 30, 110313 (2021).
31. M. Santandrea, M. Stefszky, G. Roeland, and C. Silberhorn, New J. Phys. 21, 123005 (2019).
32. J. Zhao, X. Li, T.-C. Hu, A.A. Sayem, H. Li, A. Tate, K. Kim, R. Kopf, P. Sanjari, M. Earnshaw, N.K. Fontaine, C. Wang, and A. Blanco-Redondo, (2023).
33. P.S. Kuo, Opt. Lett. 47, 54 (2022).
34. P.-K. Chen, I. Briggs, C. Cui, L. Zhang, M. Shah, and L. Fan, Nat. Nanotechnol. (2023).
35. J. Zhao, M. Rüsing, and S. Mookherjea, Opt. Express 27, 12025 (2019).
36. J.T. Nagy and R.M. Reano, Opt. Mater. Express 10, 1911 (2020).
37. Y. Niu, C. Lin, X. Liu, Y. Chen, X. Hu, Y. Zhang, X. Cai, Y.-X. Gong, Z. Xie, and S. Zhu, Applied Physics Letters 116, 101104 (2020).

What is claimed is:

1. A photonic structure comprising:
a substrate;
a waveguide formed over the substrate;
an insulator layer formed over the waveguide, wherein the waveguide is formed of nonlinear optical material; and
a tuning structure integrally formed on the photonic structure with the waveguide, the tuning structure configured for tuning the waveguide.

2. The photonic structure of claim 1, wherein the tuning structure is a micro-heater configured for application of thermal energy to a section of the waveguide.

3. The photonic structure of claim 1, wherein the photonic structure includes a plurality of tuning structures, wherein the plurality of tuning structures are configured to apply energy at different sections of the waveguide along the propagation direction of the waveguide.

4. The photonic structure of claim 1, wherein the photonic structure includes a plurality of tuning structures, wherein the plurality of tuning structures are defined by respective micro-heaters that are configured to apply thermal energy at different sections along a length of the waveguide.

5. The photonic structure of claim 1, wherein the photonic structure includes a plurality of tuning structures, wherein the plurality of tuning structures are defined by respective segmented micro-heaters that are configured to apply heat energy at different sections along a length of the waveguide, wherein the respective segmented micro-heaters are of about equal length, and wherein adjacent ones of the respective micro-heaters are about equally spaced.

6. The photonic structure of claim 1, wherein the nonlinear optical material is periodically poled ferroelectric crystalline material, wherein the photonic structure includes a plurality of tuning structures including the tuning structure,, wherein the plurality of tuning structures are defined by respective segmented micro-heaters that are configured to apply heat energy at different sections along a length of the waveguide, wherein the respective segmented micro-heaters are of about equal length, and wherein adjacent ones of the respective micro-heaters are about equally spaced, and wherein the respective micro-heaters are providing by elongated resistive loads that radiate heat in response to electrical current flowing therethrough, wherein the respective micro-heaters are configured so that, in response to electric current flowing through the respective micro-heaters, the respective micro-heaters change a dimension of the waveguide including one or more of film thickness, width or etch depth, wherein the ferroelectric crystalline material is selected from the group consisting of lithium niobate (LN), potassium titanyl phosphate (KTP), lithium tantalate (LT), GaAs, GaP, AlN, and AlGaAs.

7. The photonic structure of claim 1, wherein the photonic structure includes a plurality of tuning structures, wherein the plurality of tuning structures are configured so that, on energization of the plurality of tuning structures, the plurality of tuning structures change a dimension of the waveguide, which dimension includes one or more of film thickness, width or etch depth.

8. The photonic structure of claim 1, wherein the photonic structure includes a plurality of tuning structures including the tuning structure, wherein the plurality of tuning structures are configured so that, on energization of the plurality of tuning structures, the plurality of tuning structures tune a quasi-phase-matching spectrum of the waveguide.

9. A method for fabricating the photonic structure of claim 1, wherein the method includes fabricating the waveguide and the tuning structure with a common wafer-scale fabricating process.

10. A method for fabricating the photonic structure of claim 1, wherein the method includes fabricating the waveguide and the tuning structure with a common wafer-scale fabricating process, wherein the common wafer-scale fabricating process includes periodically poling a waveguiding material layer to impose poled regions on the waveguiding material layer and patterning the periodically poled waveguiding material layer to define the waveguide.

11. A structure comprising:
a ferroelectric crystal wafer having a substrate;
a plurality of photonic device regions patterned in the ferroelectric crystal wafer, wherein respective ones of the photonic device regions include a waveguide formed over the substrate and at least one tuning structure for tuning a spectrum of the waveguide.

12. The structure of claim 11, wherein ferroelectric crystal wafer is a lithium niobate on insulator (LNOI) wafer, and wherein the waveguide of the respective ones of the photonic device regions is patterned in a lithium niobate layer of the LNOI wafer.

13. The structure of claim 11, wherein ferroelectric crystal wafer is a lithium niobate on insulator (LNOI) wafer, and wherein the waveguide of respective ones of the photonic device regions is patterned in a periodically polled lithium niobate layer of the LNOI wafer, and wherein the at least one tuning structure of the respective ones of the photonic device regions which includes a plurality of tuning structures defined by respective micro-heaters that are configured to apply heat energy at respective different sections along the propagation direction of the waveguide.

14. A method comprising;
periodically poling, in respective device regions of a ferroelectric crystal wafer, a waveguiding material layer to impose alternatingly poled regions on the waveguiding material layer, wherein the waveguiding material layer is formed of nonlinear optical material;
patterning, in respective ones of the device regions, the waveguiding material layer to define a waveguide; and
fabricating, in respective ones of the device regions, at least one tuning structure for tuning a quasi-phase matching (QPM) spectrum of the waveguide.

15. The method of claim 14, wherein the method includes for at least one tuning structure of the device regions, tuning the QPM spectrum of the waveguide, wherein the tuning includes iteratively adjusting applied voltage to the tuning structure until the QPM spectrum features a single peak.

16. The method of claim 14, wherein ferroelectric crystal wafer is a lithium niobate on insulator (LNOI) wafer, and wherein patterning, in respective ones of the device regions, the waveguide includes patterning a lithium niobate layer of the LNOI wafer.

17. The method of claim 14, wherein the fabricating, in respective ones of the device regions, at least one tuning structure for tuning a spectrum of the waveguide which includes fabricating a plurality of tuning structures for tuning the waveguide.

18. The method of claim 14, wherein the fabricating, in respective ones of the device regions, at least one tuning structure for tuning a spectrum of the waveguide includes fabricating a plurality of tuning structures for tuning the waveguide, wherein the method includes for at least one device region of the device regions, tuning the QPM spectrum of the waveguide, wherein the tuning includes iteratively adjusting applied voltage applied to respective ones of the plurality of tuning structures until the QPM spectrum of the waveguide features a single dominant peak.

19. The method of claim 14, wherein the nonlinear optical material is lithium niobate, wherein the method includes forming, in respective ones of the device regions, electrodes for use in performing the periodic poling, applying a voltage to the electrodes to apply an electric field to the waveguiding material layer, removing the electrodes prior to the fabricating, wherein the fabricating, in respective ones of the device regions, at least one tuning structure for tuning a spectrum of the waveguide includes fabricating a plurality of micro-heaters for tuning the waveguide in the respective device regions, wherein the method includes for at least one device region of the device regions, tuning the QPM spectrum of the waveguide, wherein the tuning includes iteratively adjusting applied voltage applied to respective ones of the plurality of micro-heaters until the QPM spectrum of the waveguide of the at least one device region features a single dominant peak.

20. The method of claim 19, wherein the method includes simultaneously tuning the QPM spectra of multiple PPLN devices.
